(19) United States
(12) Patent Application Publication
(10) Pub. No.: US 2026/0321953 A1
(43) Pub. Date: Oct. 15, 2026

(54) DEVICE FOR OUTPUTTING MICROWAVE SIGNALS

(71) Applicant: University of Manitoba, Winnipeg (CA)

(72) Inventors: Can-Ming Hu, Winnipeg (CA); Yongsheng Gui, Winnipeg (CA); Bimu Yao, Shanghai (CN)

(21) Appl. No.: 19/689,396

(22) Filed: May 27, 2026

Related U.S. Application Data
(63) Continuation of application No. 19/515,885, filed on Sep. 12, 2024.
(60) Provisional application No. 63/583,894, filed on Sep. 20, 2023.

(51) Int. Cl. H01P 7/06; H01P 3/08

(52) U.S. Cl. CPC H01P 7/06; H01P 3/081

(57) ABSTRACT

A device for outputting a microwave signal comprises at least one port for respective coupling to an external microwave circuit, a microwave structure operatively coupled to the one or more ports and configured to transmit the microwave signal, a magnetic source for providing a static magnetic field and a ferromagnetic body arranged in the static magnetic field and proximal to the microwave structure to be in presence of electromagnetic fields emanating therefrom. The microwave structure includes one or more transmission lines respectively associated with the one or more ports and an active cavity resonator electromagnetically coupled thereto and configured to form a regenerative microwave signal exhibited along the transmission lines. The ferromagnetic body is arranged relative to the microwave structure such that an induced electromagnetic field thereof interacts with the electromagnetic fields of the microwave structure to form a pair of hybridized polariton modes, only one of which acts to output the microwave signal.

### CROSS-REFERENCE TO RELATED APPLICATIONS

This application is a continuation of U.S. Nonprovisional application Ser. No. 19/515,885, filed Mar. 3, 2026, which is a national stage of PCT Application No. PCT/CA2024/051199, filed Sep. 12, 2024, which claims priority benefit of U.S. Provisional Patent Application No. 63/583,894, filed Sep. 20, 2023, all of which are incorporated herein by reference in their entirety.

### FIELD OF THE INVENTION

The present invention relates generally to a device for outputting microwave signals, and more particularly to such a device with an active cavity resonator and a ferromagnetic body which is physically distinct therefrom.

### BACKGROUND

One of the recent spotlights in the realm of light-matter interaction is the renaissance of the cavity magnon polariton (CMP) [1-6]. It has led to the emergence of cavity magnonics [7] that uses the magnon as a key component for developing classical and quantum computing systems [8]. Over the past decade, CMP has attracted broad interest from communities studying quantum information [9], cavity QED [10], and cavity optomechanics [11-13]. It has enabled the innovation of magnonic memories [14, 15], cavity spintronics [6, 16], quantum sensors [17], and a variety of transducers [8, 18]. Intriguing effects such as polariton bistability [19], level attraction [20-22], exceptional points [23], Floquet ultrastrong coupling [24, 25], unidirectional invisibility [26], and bound states in the continuum have been observed in cavity magnonics. All these progresses stem from the hybrid nature of the CMP, which enables using photons to control magnons and vice versa. However, this benefit comes at a cost: the light-matter interaction, in general, produces non-degenerate polariton states, so that photon states depend on the superposition of polaritons oscillating at different frequencies with different phases and damping rates. This effect causes amplitude modulation and phase aberration for photons, hindering photonic applications that require stable monochromatic operation with well sustained photon coherence.

It has been pondered whether light-matter hybridization, monochromatic operation, and sustained photon coherence be engineered to coexist in polaritonics. The answer is yes, but the only example that nature has taught us is Bose-Einstein condensation (BEC) of cavity exciton polariton [28-30]. Although polariton BEC has invigorated polaritonics and transformed laser technology [31], it is not a silver bullet since BEC is not easy to realize in most polariton systems. Another approach, proposed very recently, was to integrate magnon-photon coupling with the spintorque effect, generating macroscopic phase coherence in spin-torque oscillators [32]. Yet, this intriguing idea awaits experimental validation.

Additionally, it will be appreciated that unlike their optical counterparts (lasers), the best coherent microwave source: masers, have not been widely used due to the extreme operating conditions (either high vacuum or low temperature), low output power (a few pW), and high input laser power (up to kW).

### SUMMARY OF THE INVENTION

According to an aspect of the invention there is provided a device for outputting a microwave signal, comprising:
one or more ports each arranged for coupling to an external microwave circuit configured to emit or receive microwaves, wherein the one or more ports include an output one of the ports configured to emit the microwave signal;
a microwave structure operatively coupled to the one or more ports and configured to transmit the microwave signal, wherein the microwave structure includes:
   one or more transmission lines respectively associated with the one or more ports, wherein each of the transmission lines spans from a first end free of electrical connection to a second end electrically connected to an associated one of the one or more ports;
   an active cavity resonator electrically or magnetically coupled to each of the one or more transmission lines, wherein the active cavity resonator is configured to form a regenerative microwave signal at a prescribed resonant frequency which is exhibited along the one or more transmission lines, wherein the active cavity resonator includes a passive cavity structure configured to define the prescribed resonant frequency by supporting a standing microwave having a wavelength inversely proportional to the prescribed resonant frequency, and wherein the active cavity resonator further includes a microwave amplifier electrically connected to the passive cavity structure and configured to augment a magnitude of the standing microwave supported by the passive cavity structure whereby the standing microwave exhibits self-oscillation;
a magnetic source arranged to provide a static magnetic field; and
a ferromagnetic body disposed in the static magnetic field and proximal to the microwave structure so as to be located in presence of electromagnetic fields emanating from the microwave structure and arranged so that an induced electromagnetic field emanating from the ferromagnetic body having a resonant frequency interacts with the electromagnetic fields of the microwave structure to form a pair of hybridized polariton modes, only one of the pair of hybridized polariton modes acting to output the microwave signal.

This provides an arrangement capable of generating microwave signals based on gain-driven oscillation and gain-driven light-matter interactions.

Typically, the microwave amplifier is configured to receive DC electrical power. Typically, the DC electrical power is received as input through a biasing circuit.

In the illustrated arrangement, a position of the ferromagnetic body relative to the microwave structure is adjustable such that the device is configured to be tuned to output the microwave signal having different frequencies.

In the illustrated arrangement, the active cavity resonator includes a variable capacitor having a capacitance value that is adjustable and electrically connected to the passive cavity structure such that the prescribed resonant frequency of the active cavity resonator is variable by changing the capacitance value of the variable capacitor.

In the illustrated arrangement, the magnetic source is a permanent magnet.

In the illustrated arrangement, the ferromagnetic body comprises a ferrimagnetic material.

In the illustrated arrangement, the ferromagnetic body comprises yttrium iron garnet.

In the illustrated arrangement, the microwave structure is formed on a printed circuit board such that the one or more transmission lines and the passive cavity structure are respectively in the form of a microstrip.

In the illustrated arrangement, the ferromagnetic body is adjacent a side of the printed circuit board (PCB) on which the one or more microstrip transmission lines and the microstrip passive cavity structure are formed. However, in other arrangement, the ferromagnetic body may be positioned on the opposite side of the PCB with respect to the microstrip structures.

In the illustrated arrangement, the passive cavity structure is in the form of a transmission line following a non-linear path between opposite ends which are free of electrical connection with the one or more transmission lines respectively associated with the one or more ports.

In other words, the passive cavity structure, when in the form of a transmission line, is not straight or linear between its opposite ends; instead, it has a plurality of turns.

Preferably, the passive cavity structure in the form of the transmission line is symmetrical about a central axis/plane between the opposite ends and dividing the passive cavity structure into equal and mirror-like halves.

The device may be used as an amplifier when the one or more ports includes an input one of the ports configured to receive an input microwave signal.

In one arrangement, the microwave amplifier comprises a transistor configured for use as an amplifier.

In one arrangement, the transistor is a bipolar junction transistor (BJT).

In another arrangement, the transistor is a high electron mobility transistor (HEMT).

In another arrangement, the transistor is a metal-semiconductor field-effect transistor (MESFET).

Typically, the bipolar junction transistor is arranged in common-emitter configuration to be usable as an amplifier. However, the common-base configuration should also be suitable for the proposed application. In the case of HEMTs, both common-gate and common-source configurations are applicable.

### BRIEF DESCRIPTION OF THE DRAWINGS

In the detailed description below, one or more preferred embodiments of the invention is described in conjunction with the following drawings in which:

FIG. 1 schematically compares cavity magnon polaritions (CMP) and gain driven polaritons (GDP). (a) Conventional CMP modes characterized by Rabi oscillations and (b) level repulsion. (c) GDP that leads to a photon steady state and (d) self-selection of a bright polariton mode. (e) schematic device architecture showing the one-photon gain G and the two-photon damping rate γ|α|². (f) For closed cavity magnonics, the phase of the GDP (solid greytone) exhibits a singularity at Δ=0, resembling the phase of a driven oscillator (dashed curve). The phases of the two CMP modes (top and bottom greytone dotted curves) are plotted for comparison.

FIG. 2 shows plots of phase singularity. (a) |S₂₁(ω)| measured in the “no-memory” setting by sweeping ω, with the detuning increased from −42 to 40 MHz. The dispersion of the bright GDP mode, measured by (b) increasing and (c) decreasing Δ in the no-memory setting. The vertical arrows in (b) mark the detunings for the spectra presented in (a). (d) Numerically calculated θ(A) at different initial conditions, where the sharp boundary marks the phase singularity. Solid curves correspond to |m(0)|² calculated for different sweeping settings. (e) The dispersion measured by increasing and (f) decreasing Δ in the “memory” setting. The solid and dotted curves in (b), (c) and (e), (f) are the fitted GDP and CMP dispersions, respectively.

FIG. 3 schematically shows coherent emission. (a) The power spectral density of the microwave emission measured at Ω/2 π=3.600 GHz. (b) The heterodyne demodulation circuit to perform real-time in-phase (I) and quadrature (Q) measurements. LO represents a local oscillator. The IQ histograms measured by setting the cavity amplifier at (c) 0, (e) 0.77, and (g) 7 V, showing the enhanced amplitude coherence by increasing G. The output power (I²+Q²) is calibrated and converted to the photon number N, and the obtained photon number statistics P(N) is fitted to exponential and/or Gaussian distributions in (d), (f), and (h).

FIG. 4 schematically shows coherent amplification. (a) An ultrahigh-quality weak microwave signal is injected at ωᵢₙⱼ/2π=Ω/2π=3.594 GHz from a signal generator into the GDP. (b) The output power spectral density S(f) of the photons emitted by the GDP. (c) The S(f) measured by changing the frequency of the injection tone ωᵢₙⱼ. The number n indicates the index of the sideband harmonics. Solid curves A and B are calculated from the theory developed by Adler. (d) Within the injection locking bandwidth of Δf=1.6 MHz, the GDP enables about 40 dB coherent amplification [deduced along the diagonal line in (c)].

FIG. 5 shows a novel single-port device for outputting microwave signals according to one embodiment of the present invention.

FIG. 6 shows a novel multi-port device for outputting microwave signals according to another embodiment the present invention.

Figure S1 shows (a) the GDP relative phase θ (in greytone) as a function of detuning Δ=ωₘ−ω_{c}, which are simulation results according to Eq. (S11). For comparison, the dotted lines are the CMP relative phases θ₊ and θ₋ calculated according to Eq. (S7), and the dashed line is the phase ψ of a driven oscillator calculated according to Eq. (S2b). (b) CMP dispersion calculated according to Eq. (S5) and (c) the simulated GDP dispersion. Time evolution Re[a(t)] of (d) the bare van der Pol oscillator according to Eq. (S10) with a₀~0, (e) the CMP system according to Eq. (S8a), and (f) the GDP system using the simulation results of Eq. (S11). The parameters of the simulation are ω_{c}/2π=3.6 GHz and λ/2π=0.9 MHz for the driven oscillator, ω_{c}/2π=3.6 GHz, κ_{c}=0, κₘ/2π=0.9 MHz and J/2π=6 MHz for the CMP system, and ω_{c}/2π=3.6 GHz, (G−κ_{c})/2π=25 MHz, γ/2π=2.6× 10⁻¹² MHz, κₘ/2π=0.9 MHz and J/2π=6 MHz for the GDP system with initial conditions A(0)~0, M(0)~0 and θ(0)~0.

Figure S2 shows (a) Frequencies Ω (greytone overlaid linespans and interconnection therebetween), ω₊ and ω₋, (b) damping parameters δω₊ and δω₋, (c) phases θ (greytone overlaid linespans and interconnection therebetween), θ₊ and θ₋, and (d) amplitudes of GDP steady-state vector |P₊| and |P₋| as a function of detuning under no-memory setting excitation, i.e., A(0)~0 and M(0)~0. Dashed line in (a) represents the magnon frequency ωₘ. The device parameters used are ω_{c}/2π=3.6 GHz, (G−κ_{c})/2π=25 MHz, γ/2π=2.6×10⁻¹² MHz, κₘ/2π=0.9 MHz, and J/2π=6 MHz.

Figure S3 shows (a) Frequencies 22 (greytone overlaid linespans and interconnection therebetween), ω₊ and ω₋, (b) damping parameters δω₊ and δω₋, (c) phases θ (greytone overlaid linespans and interconnection therebetween), θ₊ and θ₋, and (d) amplitudes of GDP steady-state vector |P₊| and |P₋| as a function of detuning under no-memory setting excitation, i.e., A(0)~0 and M(0)~0. Dashed line in (a) represents the magnon frequency ωm. θ_{±} in (c) is vertically offset by θ_{Γ} for comparison. The device parameters used are ω_{c}/2π=3.588 GHz, (G−κ_{c})/2π=170 MHz, γ/2π=2.6×10⁻¹² MHz, J/2π=4.5 MHz, Γ/2π=6.1 MHz, φ=37°, and κₘ/2π=0.9 MHz.

Figure S4 shows (a) The simulated phase θ at A(0)=Ac mapped as a function of the magnon amplitude M(0) and the detuning Δ. The A(B) line is the simulation result for up-sweep (down-sweep) detuning under memory setting, i.e., A(0), M(0), and θ(0) take the previous steady-state solution. The device parameters are ω/2π=3.588 GHz, (G−κ_{c})/2π=170 MHz, γ/2π=2.6×10⁻¹² MHz, J/2π=4.5 MHz, ΓT/2π=6.1 MHz, φ=37°, and κₘ/2π=0.9 MHz.

Figure S5 shows, in an upper panel thereof, a schematic diagram of a measurement setup used in experimental development of the invention. The resonator is emphasized in darker greytone. The inductors L=1 μH are for isolating microwave to low-frequency signal and resistors R₁=R₂=15Ω, R₃=2 kΩ, and R_{L}=100Ω for the current limit. The ground plane vias used can help to avoid ground loops. The magnetic sample used is a 1-mm diameter yttrium iron garnet (YIG) sphere mounted on a probe attached to an x-y-z stage so that its position can be well controlled with a 5 μm resolution. The external magnetic field is applied along z-direction, and the simulated distribution of the microwave magnetic field is colour-mapped near the resonator. A loop antenna is only used for calibrating the ferromagnetic resonance and not for measurements presented in the main text. (Lower panel) Three different measurement setups: microwave transmission for the GDP dispersion, microwave photon statistics for measuring the coherence of the emitted microwave and injection locking for measuring coherent amplification. The output power of the vector network analyzer is kept at −50 dBm for measuring the microwave transmission. The setup of the GDP emission measurement is similar to the injection locking measurement, except that no external microwave is injected into the cavity.

Figure S6 shows hysteresis GDP dispersion measured at different heights.

Figure S7 shows (a) Typical microwave transmission |S₂₁|² (symbols) for the magnon mode and its complex Lorentzian lineshape fitting (solid line). (b) Magnon resonance frequency Om as a function of the magnetic field H. (c) Magnon damping rate κₘ as a function of ωₘ.

Figure S8 shows (a) Microwave transmission |S_{21|}² measured for zero bias voltage (symbols) and the Lorentzian lineshape fitting (solid line).

Figure S9 shows (a) Microwave transmission |S_{21|}² measured for three typical conditions: zero bias voltage (A), near threshold (0.75V, B), and far above threshold (7 V, C) (b) |S₂₁ (ω_{c}) |2 as a function of the bias voltage. The VNA output power is −50 dBm for all measurements.

Figure S10 shows (a) ω-ωₘ transmission mapping at V=0.82 V. (b) Typical spectra for the bare cavity and at the matching condition Δ=0. Solid lines in (b) were calculated according to Eq. (S29), with κₘ/2π=0.9 MHz, κ_{c}/2π=142 MHz, G/2π=149.7 GHz, and J/2π=4.5 MHz.

Figure S11 shows measured GDP dispersions at different condition. Symbols are experimental results and solid curves are simulation results based on Eq. (S21). The adjusted parameters are G/2π=312 MHz, ΓT/2π=6.1 MHz, and φ=37°. Other device parameters κ_{c}/2π=142 MHz, γ/2π=2.6 10⁻¹² MHz, J/2π=4.5 MHz, and κₘ/2π=0.9 MHz are calibrated by other independent experiments.

Figure S12 shows (a) Power spectral density S(f) of microwave emission measured for three typical conditions: zero bias voltage (A), near threshold (0.77V, B), and far above threshold (7 V, C) (b) The integrated microwave power and (c) photon number as a function of the bias voltage.

Figure S13 shows (a) IQ histogram data at zero bias voltage (gain off). (b) Photon number distribution (symbols) p(N) and the fitting result (solid line) based on thermal distribution.

Figure S14 shows (a) IQ histogram data for bias voltage I near the threshold Vₜₕ. (b) Photon number distribution (symbols) p(N) and the fitting result (solid line) based on the superposition of thermal distribution and Gaussian distribution.

Figures S15 shows (a) For V~Vₜₕ time series I(t) of the emission over a period of 350 μs. (b) Oscillation of the superthreshold state. (c) Noise of the subthreshold state.

Figure S16 shows (a) IQ histogram data for bias voltage V>>Vₜₕ. (b) Photon number distribution (symbols) p(N) and the fitting result (solid line) based on a Gaussian distribution.

Figure S17 shows (a) Power spectral density S(f) (symbols) measured at V>>Vₜₕ and fit to a Gaussian lineshape exp

$$[ - \frac{{( ω - Ω )}^{2}}{2 {σ}^{2}} ]$$

(solid lines) with σ/2π=180 Hz. (b) The modulus of the degree of the first-order coherence |g⁽¹⁾(τ)| calculated from time-domain IQ measurement according to Eq. ((S30) at V>>Vₜₕ and V=0. The solid lines are the fitting results base on

$$\vert {g}^{( 1 )} ( τ ) \vert = exp ( - \frac{1}{2} \frac{{τ}^{2}}{{τ}_{c}^{2}} )$$

and the dashed line indicates |g⁽¹⁾(τ=τc)|=0.61.

Figure S18 shows (a) Power spectral density S(f) mapping as a function of the frequency of the injected tone for input power Pᵢₙⱼ=1 μW (−30 dBm). The number n indicates the index of the sideband harmonics. The emission is injection locked for a frequency range of Δf=1.6 MHz. The predicted frequencies according to Eq. (S27) are plotted as a thick darker line for the central pulled emission (n=0) and the thin paler lines for sideband emission, respectively. (b) Injection locked GDP S(f) spectra (darker symbols) measured at zero detuning between the input frequency and GDP frequency, ωᵢₙⱼ/2π=Ω/2π=3.594 GHz, indicated by the dark arrow in (a). The solid line is the Gaussian lineshape fit with σ/2π=0.42 Hz, and the dashed line superimposes a broad Gaussian distribution (σ/2π~15 Hz) with an amplitude of 10⁻⁶ as the main beam. The paler symbols are the injected signal (×10⁴) for comparison. (c) Δf as a function of Pᵢₙⱼ where solid symbols are extracted from the S(f) mapping and the solid line is a fit to Δf=ξ\sqrt{Pᵢₙⱼ} with ξ=60 MHz/\sqrt{mW}.

### DETAILED DESCRIPTION

### Detailed Embodiments

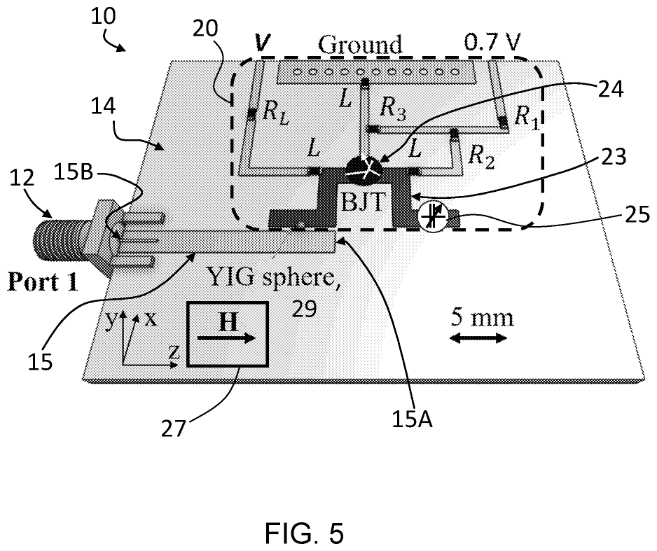

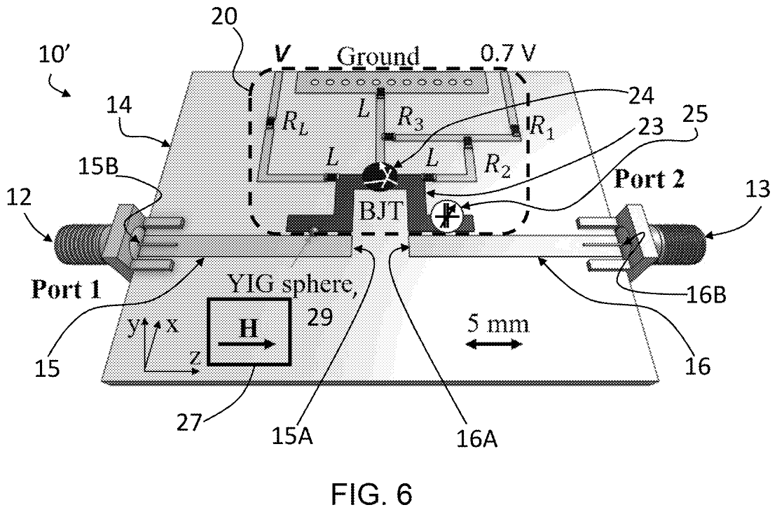

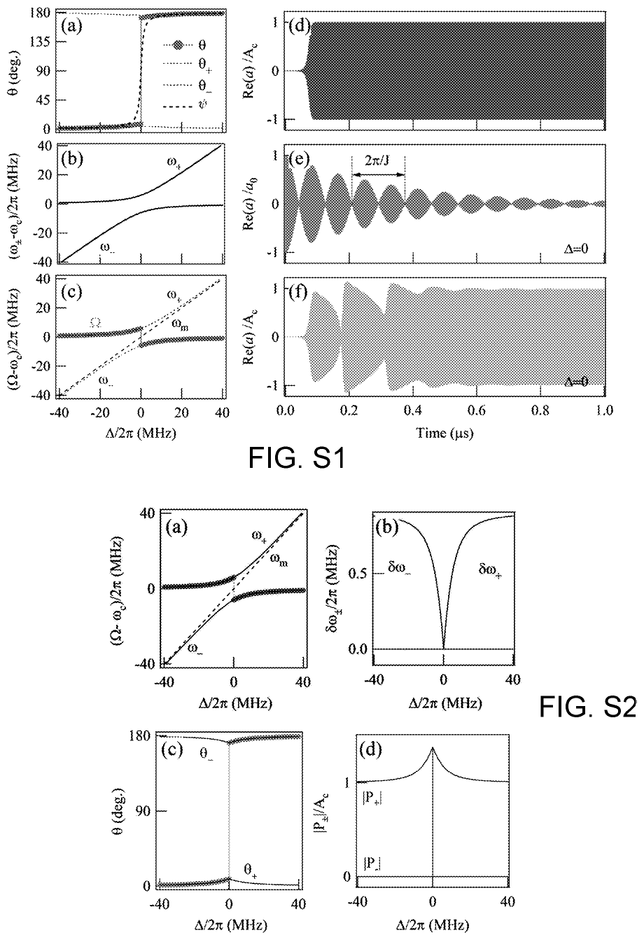

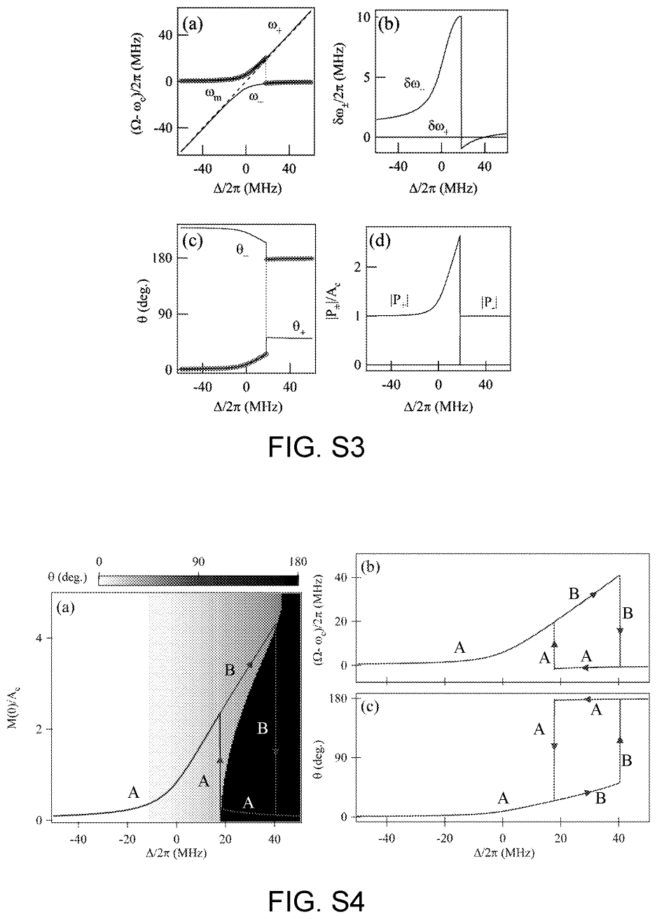

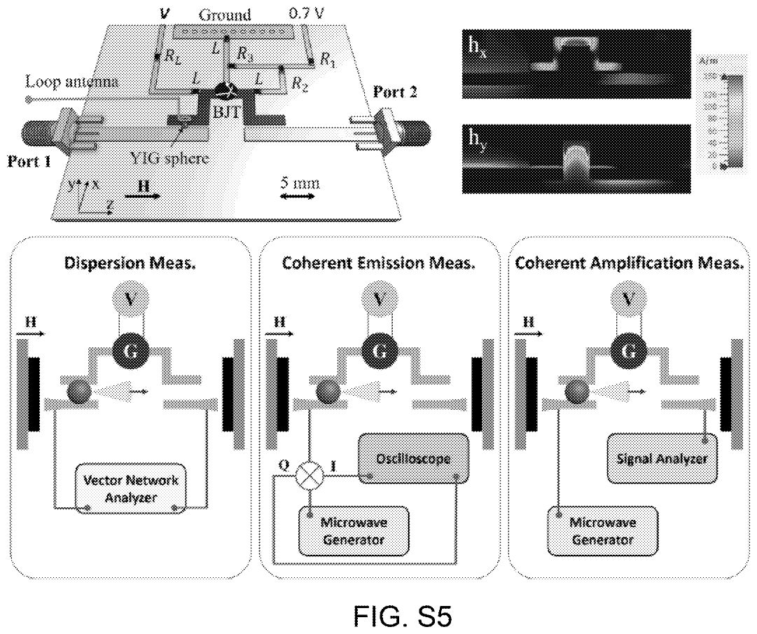

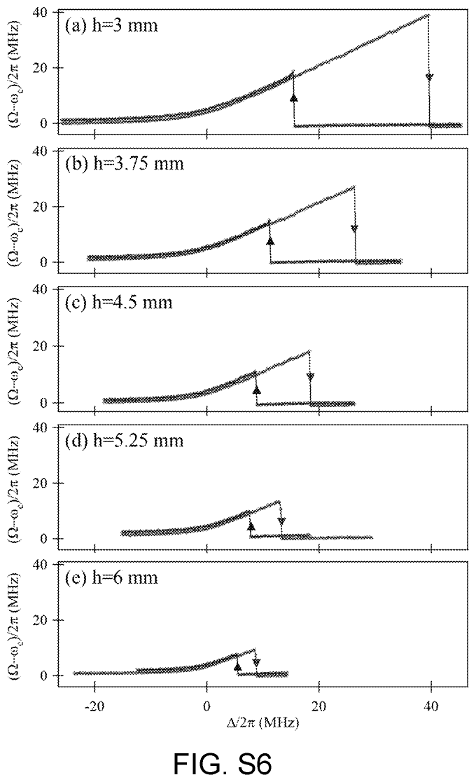

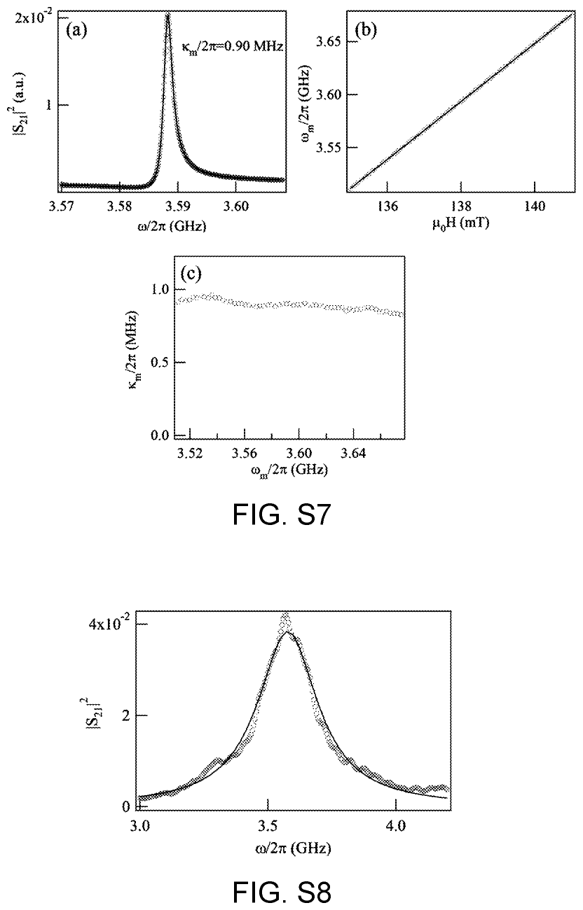

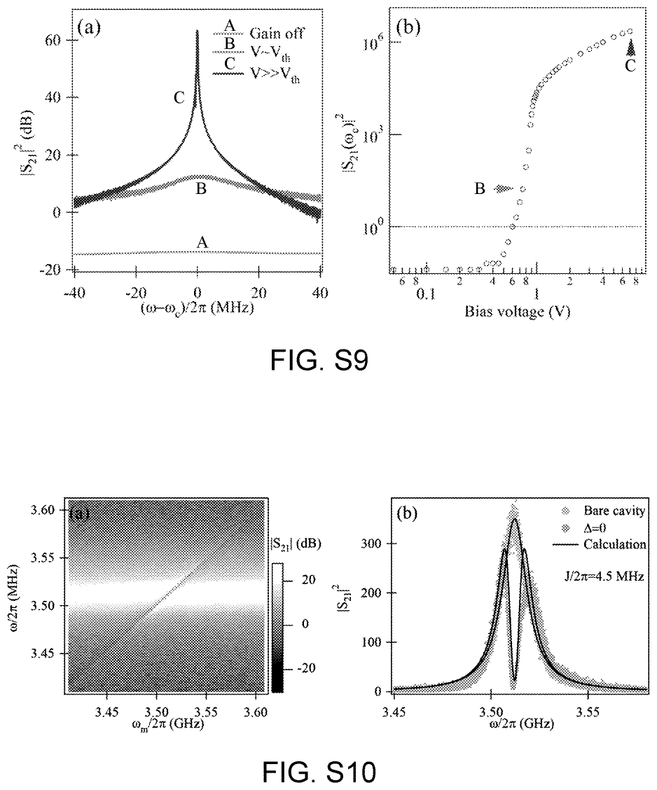

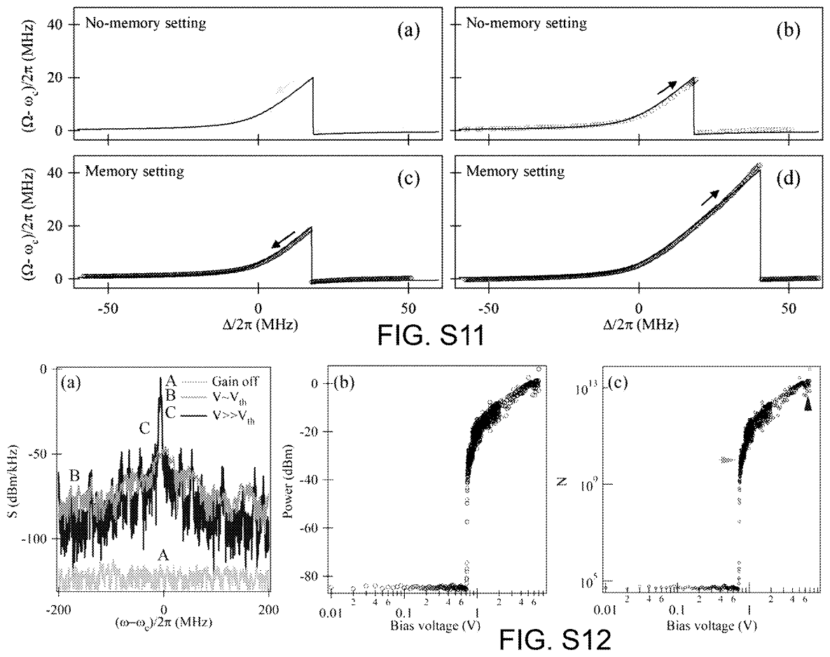

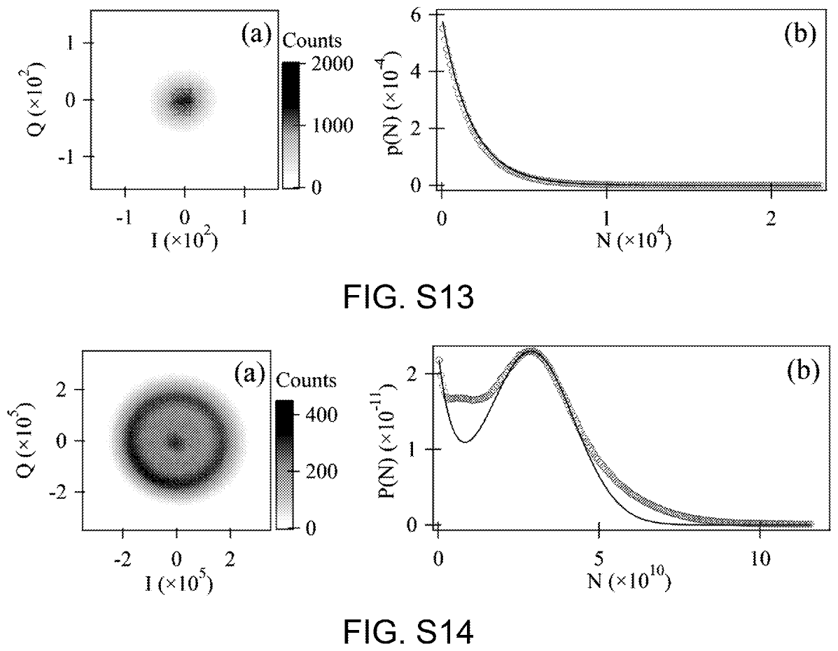

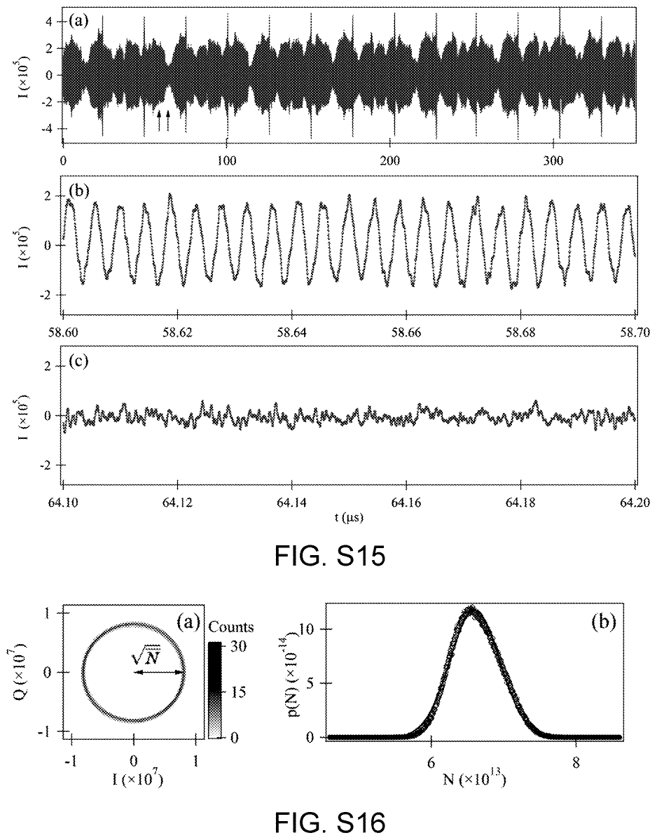

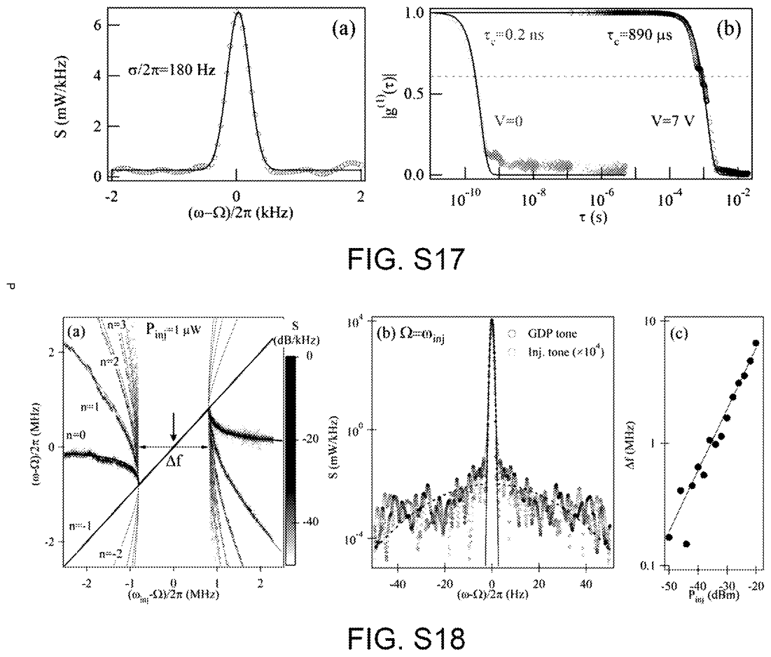

Referring initially to FIGS. 5 and 6 to provide enabling disclosure of workable embodiments of the present invention, illustrated in each of these figures is disclosed a device for outputting a microwave signal, which is generally indicated at 10 or 10′. The device is particularly suited for use as a microwave source or as a microwave amplifier, as will be better appreciated shortly.

Generally speaking, the device 10, 10′ comprises one or more ports, such as 12 and 13, each arranged for coupling to an external microwave circuit or device configured to emit or receive microwaves. The one or more ports include at least an output port 12 configured to emit the microwave signal. In a one-port embodiment like that of FIG. 5, the device 10 is operable as a microwave source only. In a multi-port embodiment like that of FIG. 6, in which there are typically two ports, the other one of which is an input port 13 configured to receive an input microwave signal, the device 10′ is additionally operable as an amplifier.

Furthermore, the device 10 or 10′ generally comprises a microwave structure 14 operatively coupled to the one or more ports 12, 13 and configured to transmit the microwave signal. That is, the microwave structure 14 is coupled to each of the ports in such a way as to exchange microwaves therebetween. The microwave structure 14 includes one or more transmission lines, such as 15 and 16, respectively associated with the one or more ports 12, 13. In the single-port arrangement, there is only one transmission line, in this case 15, and in the illustrated multi-port arrangement, in which there are two ports, there are two transmission lines 15, 16.

Regardless of the number of ports and transmission lines, each transmission line such as 15 or 16 spans from a first end, in this case indicated at 15A, 16A, which are free of electrical connection, and to a second end, in this case indicated at 15B, 16B, which is electrically connected to the port with which the transmission line is associated 12 or 13. That is, the first end of each transmission line of the microwave structure is not electrically connected to any other electrical component, such that each transmission line only has one electrical load, that is the respective port associated therewith. Furthermore, when there are plural transmission lines, the first ends 15A, 16A of the transmission lines are spaced apart so as to be physically separated from one another. In the illustrated multi-port arrangement, the port-connected transmission lines are colinear so as to lie along a common (imaginary) line (passing through the transmission lines).

The microwave structure 14 of the device further comprises an active cavity resonator 20 respectively electrically or magnetically coupled to the one or more transmission lines 15, 16, that is the active cavity resonator 20 is electrically or magnetically coupled to each port-connected transmission line of the microwave structure. The active cavity resonator 20 is configured to form a regenerative microwave signal at a prescribed resonant frequency which is exhibited along the one or more port-connected transmission lines. It will be appreciated that this electrical or magnetic coupling between the active cavity resonator and the port-connected transmission lines is not mutually exclusive, and that the coupling may be both electrical and magnetic. In other words, the active cavity resonator is electromagnetically coupled to the port-connected transmission lines, regardless of which portion—electrical or magnetic—is dominant.

To form the regenerative microwave signal, the active cavity resonator 20 includes a passive cavity structure 23 configured to define the prescribed resonant frequency by supporting a standing microwave having a wavelength inversely proportional to the prescribed resonant frequency, and a microwave amplifier 24 (schematically shown) electrically connected to the passive cavity structure 23 and configured to augment a magnitude of the standing microwave supported by the passive cavity structure, whereby the standing microwave exhibits self-oscillation.

The prescribed resonant frequency of the active cavity resonator is based on, so as to be determined by, (i) size and shape of the passive cavity structure, which typically are fixed so as not to be variable or adjustable; (ii) biasing voltage of the microwave amplifier 24, which may be variable; and (iii) an optional variable capacitor 25 electrically connected to the passive cavity structure. More specifically, regarding aforementioned item (iii), the active cavity resonator may include, as in the illustrated embodiments, a variable capacitor 25 having a capacitance value that is adjustable. The variable capacitor is of a conventional construction, and its capacitance may be adjustable for example by applying additional DC electrical voltage to the capacitor 25 or by mechanical trim. In such embodiments of the device with the variable capacitor, the capacitor 25 is electrically connected to the passive cavity structure 23, for example by being placed within the cavity structure, so that the active cavity resonator is configured to have adjustable capacitance. Thus, the resonant frequency of the active cavity resonator may be adjusted by changing the biasing voltage of the microwave amplifier and/or the capacitance value of the variable capacitor electrically connected to the passive cavity structure.

Further to the foregoing constituent components of the microwave-output device 10, the device 10 also includes a magnetic source 27 arranged to provide a static magnetic field, generally in proximity or substantially adjacent to the microwave structure, and a ferromagnetic body 29 disposed in the static magnetic field and proximal to the microwave structure 24 so as to be located in presence of electromagnetic fields emanating from the microwave structure. The ferromagnetic body 29 is arranged so that an induced electromagnetic field emanating from the ferromagnetic body having a resonant frequency interacts with the electromagnetic fields of the microwave structure to form a pair of hybridized polariton modes, only one of the pair of hybridized polariton modes acting to output the microwave signal. The resonant frequency of the ferromagnetic body 29 may be the same or different from the resonant frequency of the active cavity resonator 20.

The microwave structure 14 may be substantially outside the static magnetic field of the magnetic source 27, so that electromagnetic signals transmitted by the microwave structure are not affected thereby.

The two hybridized polariton modes exhibit distinct dependencies on the (resonant) frequencies of the uncoupled passive cavity structure and ferromagnetic body.

In the illustrated embodiments, a position of the ferromagnetic body relative to the microwave structure is adjustable such that the device is configured to be tuned to output the microwave signal having different frequencies. That is, the physical position of the ferromagnetic body can be changed relative to the microwave structure.

In the illustrated embodiments, the magnetic source is a permanent magnet.

In the illustrated embodiments, the ferromagnetic body comprises a ferrimagnetic material.

In the illustrated embodiments, the ferromagnetic body comprises yttrium iron garnet (YIG).

Typically, as in the illustrated embodiments, the microwave structure is formed on a printed circuit board such that the one or more transmission lines and the passive cavity structure are respectively in the form of a microstrip.

In the illustrated embodiments, the ferromagnetic body is adjacent a side of the printed circuit board (PCB) on which the one or more microstrip transmission lines and the microstrip passive cavity structure are formed. However, in other embodiments, the ferromagnetic body may be positioned on the opposite side of the PCB with respect to the microstrip structures.

In the illustrated embodiments, the passive cavity structure is in the form of a transmission line following a non-linear path between opposite ends which are free of electrical connection with the one or more transmission lines respectively associated with the one or more ports. In other words, the passive cavity structure, when in the form of a transmission line, is not straight or linear between its opposite ends; instead, it has a plurality of turns. Preferably, the passive cavity structure in the form of the transmission line is symmetrical about a central axis/plane between the opposite ends and dividing the passive cavity structure into equal and mirror-like halves.

Typically, the microwave amplifier is configured to receive DC electrical power.

Typically, the DC electrical power is received as input through a biasing circuit.

In one embodiment, the microwave amplifier comprises a transistor configured for use as an amplifier.

The transistor may be a bipolar junction transistor (BJT), a high electron mobility transistor (HEMT) or a metal-semiconductor field-effect transistor (MESFET).

Typically, the bipolar junction transistor is arranged in common-emitter configuration to be usable as an amplifier. However, the common-base configuration should also be suitable for the proposed application. In the case of HEMTs, both common-gate and common-source configurations are applicable.

Furthermore, it will be appreciated that:
The static magnetic field is primarily used to bias the ferromagnetic material without substantially affecting the magnetic fields emanating from the active cavity resonator. For example, the static magnetic field is formed by permanent magnets arranged proximal to the microwave structure.
When the microwave structure is formed on a printed circuit board, the resonant frequency of the passive cavity structure is affected, so as to be partially determined, by the shape and size of the microstrip corresponding to the passive cavity structure and a material of a substrate of the PCB.
Incorporating an active microwave element in operative conjunction with a passive cavity resonator acts to transforms the cavity structure into a regenerative device. (The term “regenerative” emphasizes intentional inclusion of positive feedback due to the resonant structure, which is not a typical characteristic of a standard microwave amplifier.) In this configuration, both active components and the resonator nature act to provide gain to compensate for the inherent structural losses. Consequently, the active cavity exhibits auto-oscillations, distinguishing it from the passive cavity. The active component is powered by DC electrical power.
When the ferromagnetic body is positioned within the static magnetic field, the strength and direction of the (external) magnetic field influence or affect a resonant frequency of the ferromagnetic body.
Proximal placement of the ferromagnetic body to the microwave structure, and in particular the active cavity resonator thereof, results in formation of twin hybridized polariton modes through or due to interaction of respective electromagnetic fields emanating from the ferromagnetic body and the microwave structure, particularly the active cavity resonator.
The nature of this interaction (coherent or dissipative) and its strength are determined by the overlap of electromagnetic fields between the passive cavity structure and the magnetic body, as well as the cooperative effect arising from their mutual interaction with a shared transmission line. Accordingly, the interaction can be fine-tuned by adjusting the position of the ferromagnetic body.
These interactions, along with the auto-oscillatory nature of the active cavity, determine that one of the hybridized modes is bright (emitting microwaves), while the other remains inactive (dark mode). In other words, the inventors' research has uncovered monochromatic auto-oscillation within a polariton system, which is unexpected because polaritons exist in pairs.
Microwave chokes, such as inductors, are placed between the microwave amplifier and the power supply, typically DC, to facilitate the passage of current from the power supply via the biasing circuit while effectively blocking microwave energy from entering the power supply and the biasing circuit.

Thus provided are workable and reproducible embodiments capable of generating microwave signals based on gain-driven oscillation and gain-driven light-matter interactions.

As described hereinbefore, the present invention relates to an on-chip solid-state coherent microwave source for applications in communication, medicine, security, sensing and quantum technologies.

There is disclosed a novel polariton device that emits microwaves with remarkable coherence and high efficiency. This device is based on the gain-driven cavity magnon polariton which is suitable because it may provide:
an output power exceeding one mW,
a quality factor exceeding 10⁷,
the ability to produce both microwave pulse and continuous emission,
high tunability of the microwave frequency,
on-chip generation of a coherent microwave.

The simple fabrication and operation enables for easy integration with variety of classic and quantum devices, allowing for efficient on-chip generation and amplification of coherent microwave photons from ambient to cryogenic temperatures. In addition, the novel device possesses properties such as injection locking (with an injection linewidth of <1 Hz) and frequency-comb generation.

By utilizing gain-driven light-matter interaction, there is provided a cavity magnonics device with embedded gain, which is a new type of on-chip microwave signal source and amplifier with a remarkable coherence and high DC-to-microwave conversion efficiency. The hybridization of magnon and resonator modes in the device produces the bright and dark polariton modes. The device can spontaneously select the bright mode through gain-driven dynamics while maintaining photon coherence across the transition from symmetric to anti-symmetric polariton modes. In the illustrated arrangement, there is provided a low-damping ferromagnetic material (a 1-mm diameter sphere of yttrium iron garnet, YIG) with an active planar microwave cavity fabricated on a printed circuit board (PCB). The active cavity's biased voltage, the YIG's position to the cavity, and the static magnetic field can all be used to tune the frequency of the generated microwave signal. The microwave emission has a coherence time of 0.89 ms and yields a coherence length of 270 km. For the amplification application, the device achieved a power gain of 10,000 with a quality factor exceeding 10⁹.

The device according to at least some preferred embodiments of the present invention has the following features:
Output power in the order of mW;
2D structure;
DC to microwave power conversion efficiency: 3% and may be as high as 50% by designing a bias circuit with impedance matching.
Maximum amplification bandwidth: about 40 MHz, which may be increased by incorporating a varactor-loaded cavity, where the cavity frequency can vary several hundred MHz by a DC voltage.
Quality factor: in the order of 10⁷;
Emission coherence time: about 0.89 ms; and
High tunability in the frequency of the emission microwave.

In general, light-matter interaction produces non-degenerated polaritons, so photon states are determined by the superposition of polaritons oscillating at different frequencies with varying phases and damping rates. This effect causes photon amplitude modulation and phase aberration, making photonic applications that require stable monochromatic operation with well-maintained photon coherence difficult to implement. Polariton lasers that exploit the coherent nature of Bose condensation of exciton-polaritons in semiconductors have been realized, but they are difficulty to implement in most polariton systems. The generalizability of the approach represented by the invention, which is based on gain-driven light-matter interactions, paves the way for the development of high coherence polariton emission sources with frequencies ranging from MHz (optomechanical cavity system), GHz (cavity magnon polariton system), and THz (cavity semiconductor polariton system).

In respect of one example application of the novel device, the device generates a periodic microwave signal that can be integrated with CMOS technology and used as an embedded local clock signal generator in digital systems such as traditional computing systems. In respect of another example application, since the size of the novel device is determined by the microwave cavity involved, its dimension can be reduced by using a PCB substrate with a high dielectric constant. It is capable of being directly integrated into a quantum computing system, acting as on-chip coherent microwave sources. This capability has the potential to address issues in current quantum computing systems, which require complex wiring to deliver microwave signals to quantum computing chips.

In respect of another example application, the novel device's ultra-high-quality factor makes it an excellent candidate for sensing applications because of its ability to improve light-matter interaction. In this case, the detection sensitivity is proportional to the quality factor, and even minor perturbations near the microwave cavity can cause a significant resonance-frequency shift.

In respect of another example application, since the novel device can emit and receive electromagnetic energy, it can be built into an information communication system for data transmission and collection from distributed sources such as cell phone users.

In respect of another example application, a periodic modulation applied to either the cavity (modify the gain or cavity frequency) or the ferromagnetic body (adjust its resonance frequency) produces a frequency domain comb. By integrating it within standard electrical circuits, this on-chip device can generate hundreds of harmonics of the driving frequency and expand the application in precision frequency measurement as in optical analogue.

As described hereinbefore, and in other words, the present invention relates to a device for outputting a microwave signal, which comprises at least one port for respective coupling to an external microwave circuit, a microwave structure operatively coupled to the one or more ports and configured to transmit the microwave signal, a magnetic source for providing a static magnetic field and a ferromagnetic body arranged in the static magnetic field and proximal to the microwave structure to be in presence of electromagnetic fields emanating therefrom. The microwave structure includes one or more transmission lines respectively associated with the one or more ports and an active cavity resonator electromagnetically coupled thereto and configured to form a regenerative microwave signal exhibited along the transmission lines. The ferromagnetic body is arranged relative to the microwave structure such that an induced electromagnetic field thereof interacts with the electromagnetic fields of the microwave structure to form a pair of hybridized polariton modes, only one of which acts to output the microwave signal.

### Supportive Theory and Experimentation

The Inventors of the present application, by developing gain-embedded cavity magnonics, have revealed a new path for achieving monochromatic polariton operation with sustained photon coherence. A gain-driven polariton (GDP) is created, which exhibits distinct features such as polariton phase singularity, polariton auto-oscillations, and spontaneous polariton mode selection. Using these properties, polariton-based coherent microwave amplification and high-quality microwave emission have been demonstrated.

To explain the idea of the GDP, initial reference is made to the CMP produced in closed cavity magnonics governed by the coherent magnon-photon coupling [7],

\hat{\dot{a}}=−i\tilde{ω}_{c}â−iJ\hat{m},

\hat{\dot{m}}=−i\tilde{ω}ₘ\hat{m}−iJâ (2)

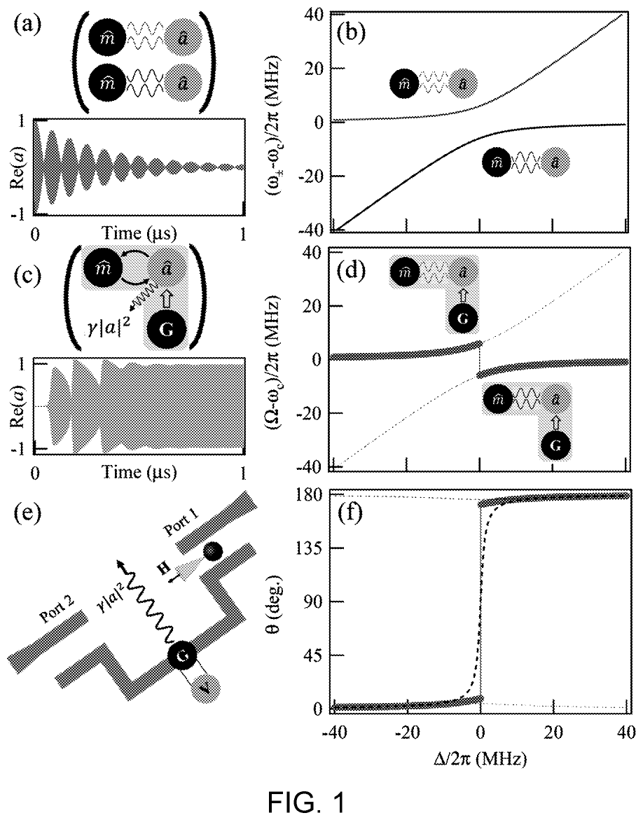

Here, \hat{\dot{a}} and \hat{\dot{m}} represent the annihilation operator of the cavity photon and magnon modes, respectively, J is the rate of the coherent coupling. \tilde{ω}_{c}=ω_{c}−iκ_{c} and \tilde{ω}ₘ=ωₘ−iκₘ where κ_{c} and κₘ are the damping rates. The solution of Eq. (1) is a pair of CMP modes \hat{p}_{±}=c_{±}â±c_{∓}\hat{m} with eigenfrequencies \tilde{ω}=\tilde{ω}+\tilde{Δ}/2±\tilde{Λ} where c_{±}=[(\tilde{Λ}∓\tilde{Δ}/2)/2\tilde{Λ}]^{1/2} are the state amplitudes with \tilde{Δ}≡\tilde{ω}ₘ−\tilde{ω}_{c} and \tilde{Λ}≡[J²+(\tilde{Δ}/2)²]^{1/2}. They show in- and out-of-phase oscillations of the magnons and photons as depicted in FIGS. 1(a) and 1(b).

The GDP is created by incorporating two new ingredients (gain and nonlinearity) into the cavity, changing its complex frequency to

\tilde{ω}_{c}=ω_{c}+i(G−κ_{c}−γ|a|²) (2)

Here, G represents the one-photon gain, a is the expectation value of â, and γ|a|² is the two-photon (nonlinear) damping rate. Setting G>κ_{c} and switching on the gain, |a(t)| exponentially increases to the steady-state value |A_{c}|, where the nonlinear damping balances the net gain with G−κ_{c}=γ|A_{c}|². At the steady state, the cavity becomes an auto-oscillator with zero damping populated with a constant number of photons n_{c}=|A_{c}|². Such a cavity resembles the gedanken oscillator conceived in 1920 by van der Pol [33,34], which has been broadly used for understanding nonlinear biological processes and quantum dynamics [35,36].

As sketched in FIG. 1(c), when coupling the zero-damping cavity with a damped oscillator, such as the magnon mode, an intriguing gain-driven light-matter interaction takes place. Mathematically, Eqs. (1) and (2) have a steady-state solution (see Supplemental Material [37]) with the expectation values a(t)=Ae^{-iΩt} and m(t)=Me^{-iΩt}ₑ^{-iθ}, where A and M are the steady-state amplitude of photons and magnons, respectively. At the steady state, magnons and photons are synchronized at the frequency Ω with a relative phase θ that depends on the detuning Δ=ωₘ−ω_{c}. Meanwhile, the CMP states \hat{P}_{±}=c_{±}â±c_{∓}\hat{m} evolve to the GDP with the steady-state amplitudes

P_{±}=c_{±}A±c_{∓}e^{-iθ}M. (3)

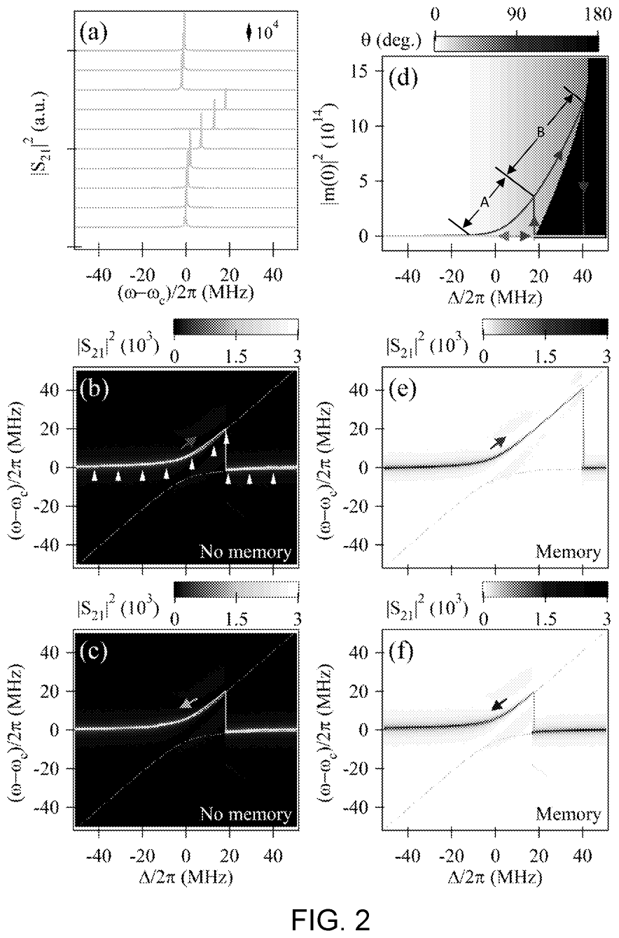

Physically, due to the nonlinear term in Eq. (2), the phase θ is set by the initial condition for Eq. (1). Solving Eqs. (1) and (2) numerically [37], two cardinal features of the GDP are found: (1) A phase singularity emerges at the critical detuning Δ_{c}, where θ switches abruptly from θ≈0 to θ≈π. In general, as demonstrated later in FIG. 2, Δ_{c} depends on the initial condition and the coupling parameters, but in the simplest case for the closed cavity magnonics operating with the initial condition a(0)~0 and m(0)~0, it is found Δ_{c}=0 where the calculated θ(Δ) plotted in FIG. 1(f) indicates that the GDP has both characteristics of a driven oscillator and polariton. (2) Along with the phase singularity, the GDP spontaneously selects a bright mode [37],

|P₋|=0, |P₊|>0, Ω≈ω₊, for Δ<Δ_{c} (4a)

|P₊|=0, |P₋|>0, Ω≈ω₋, for Δ>Δ_{c} (4b)

Equation (4) means the GDP is composed of a bright and a dark polariton mode, whose frequencies abruptly interchange at Δ_{c} as shown in FIG. 1(d). By spontaneously selecting the bright mode, the magnon and photon are in-phase synchronized at [symbol] for Δ<Δ_{c}, but they become out-of-phase synchronized at ω₋ for Δ>Δ_{c}. Hence, at any detuning, the GDP unifies light-matter hybridization with monochromatic auto-oscillation. This observation leads to sustained photon coherence, opening new avenues for polariton applications, as will be demonstrated later.

Experimentally, gain-embedded cavity magnonics were designed in order to realize practical implementation of the invention. FIG. 1(e) shows a schematic picture of such a device: A half-wavelength microstrip line resonator is connected with two measurements ports, and a voltage-controlled amplifier is engineered on the microstrip to amplify the cavity mode. A yttrium iron garnet (YIG) sphere with a diameter of 1 mm is mounted on a probe attached to an x-y-z stage so that its position is controlled with the resolution of 5 μm. Setting the YIG sphere on the cavity and applying a magnetic field H to control the Kittel mode frequency ωₘ=γₑμ₀ (|H+H_{A}), the microwave transmission and emission spectra at polariton steady states were measured. Here, γₑ=2π×27.3 GHz/T is the electron gyromagnetic ratio, μ₀H_{A}=−6.2 mT is the effective field of YIG, and μ₀ is the vacuum permeability. A dozen devices with different geometries were measured by placing the YIG sphere at different positions, all of which exhibited the same feature as summarized by Eq. (4). The data presented below were rendered from one of our typical devices with parameters ω_{c}/2π=3.588 GHz. κₘ/2π=0.9 MHz, κ_{c}/2π=142 MHz, and γ/2π=2.6×10⁻¹² MHz. In this gain-embedded device, in addition to the coherent coupling rate of J/2π=4.5 MHz the insertion of the amplifier exposes magnons and cavity photons to the environmental photon bath, which induces a dissipative magnon-photon coupling with the rate Γ/2π=6.1 MHz. This effect shifts Δ_{c} from zero, as is displayed in FIG. 1(d) for the simple case of the closed cavity magnonics, but as will be seen from the experimental data presented in FIG. 2, it does not change the cardinal feature summarized by Eq. (4). The gain is controlled by a dc voltage V. Unless specified, the data are measured at V=7 V with G/2π=312 MHz.

FIG. 2(a) shows the microwave transmission spectra |S₂₁(ω)| measured by using the vector network analyzer to sweep the frequency ω. The power level of the probe signal is kept at −50 dBm. As predicted by Eq. (4), instead of level repulsion of twin CMP, only one bright GDP mode is observed, which suddenly changes its mode frequency at Δ_{c}. The dispersion of the bright GDP mode, measured by either increasing or decreasing Δ, is plotted in FIGS. 2(b) and 2(c), respectively. In both cases, we determine Δ_{c}/2π=18 MHz.

To quantitatively analyze Δ_{c} in the devices, θ(Δ) was numerically calculated by generalizing Eq. (1) to open cavity magnonics [37]. The obtained phase mapping, by setting a(θ)=A_{c} and changing m(0), is plotted in FIG. 2(d), where the sharp boundary marks the phase singularity. The experimental data of FIGS. 2(a)-2(c) are measured in the no-memory setting: at each detuning, the gain is switched on before measuring |S21(ω)|, and then it is switched off before changing to the next Δ. This setting corresponds to the initial condition of m(0)=0 at each detuning, as indicated by the horizontal line in FIG. 2(d), where it was found Δ_{c}/2π=18 MHz.

Changing the initial condition m(0), Δ_{c} shifts as shown in FIG. 2(d). To verify such nonlinear characteristics, further measurement was made of the microwave transmission in the memory setting, where the gain was kept on while changing Δ. In this setting, as shown by curves A and B in FIG. 2(d), m(0), at the next detuning “remembers” the steady-state value of the previous detuning, so that Δ_{c} should depend on the sweeping history. Indeed, as shown in FIGS. 2(e) and 2(f), the measured phase singularity appears at Δ_{c}/2π=40 and 18 MHz for up and down sweeping, respectively. Using the same set of device parameters (see Supplemental Material [37]), the fitted GDP dispersions (solid curves) agree very well with the measured dispersions in all cases that are shown in FIGS. 2(b), 2(c), 2(e), and 2(f). Thus achieved was the GDP that spontaneously selects a bright polariton mode. Such a unique polariton enables gain-sustained photon coherence, as demonstrated below in photon emission experiments.

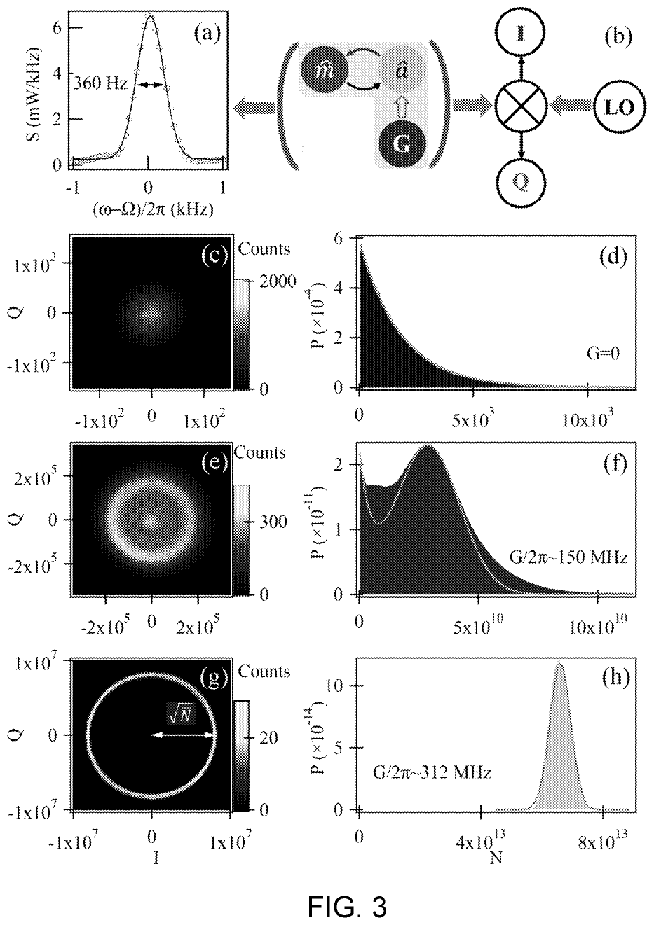

Emission spectra are measured in the memory setting at Δ=0 when up sweeping. Without any probe signal, a signal analyzer was used to measure the power spectral density S(f) of the emitted photons. As shown in FIG. 3(a), an emission peak of about 4.3 mW was detected with S(f)=6.5 mW/kHz at Ω/2π=3.600 GHz. The measured linewidth (full width at half maximum, or FWHM) was 360 Hz, which is remarkable for magnetic systems: via the light-matter interaction, the FWHM is 3 orders of magnitude smaller than the magnon damping (~900 kHz) that limits the quality factor of spin-torque oscillators [52-54]. Furthermore, the measured FWHM exceeds the performance of the proposed spin-torque-oscillator maser, where simulations indicate an upper bound emission linewidth of about 4 kHz [32].

To quantitatively analyze the photon coherence, the statistics of the emitted photons were investigated. First the emission signal was mixed through a modulator board with a local oscillator and then the down-converted in-phase (I) and quadrature (Q) (90° out-of-phase) signals were recorded with an oscilloscope. The gain dependence of the amplitude coherence is systematically shown in FIG. 3. At V=0 with G=0, the IQ histogram in FIG. 3(c) shows all outputs around zero. The output power of (I²+Q²) was calibrated and converted to the photon number N, and the obtained photon number distribution P(N) is described as an exponential distribution in FIG. 3(d), indicating incoherent emission subjective to thermal and charge noises [55]. Tuning the voltage to 0.77 V (G≈κ_{c}), outside of the center spot of the noise signal, the histogram in FIG. 3(e) develops nonzero outputs with a donut shape that agrees with the distribution of a coherent source [55]. Here, P(N) can be approximately fitted by a combined exponential and Gaussian distribution in FIG. 3(f), where the Gaussian distribution indicates the onset of coherent emission. Setting V=7 V (G>>κ_{c}), the IQ histogram vanishes at the center and uniformly distributes in a ring in FIG. 3(g). The histogram in FIG. 3(h) can be well fit by the Gaussian line shape P(N)~e^{(N-N̅)}^{²}^{/2σ}^{²} with N̅=(6.600±0.001)×10¹³ and σ=(3.40±0.01)×10¹², demonstrating amplitude coherence of the emitted photons [56]. Furthermore, study was made of the phase coherence of the emission by analyzing the first-order coherence function g⁽¹⁾(τ), which constitutes as the convolution of the IQ signal and its complex conjugate with time delay t. It was deduced that, at V=7 V, the phase coherence time reaches 0.9 ms, confirming the gain-sustained photon coherence of the GDP [37].

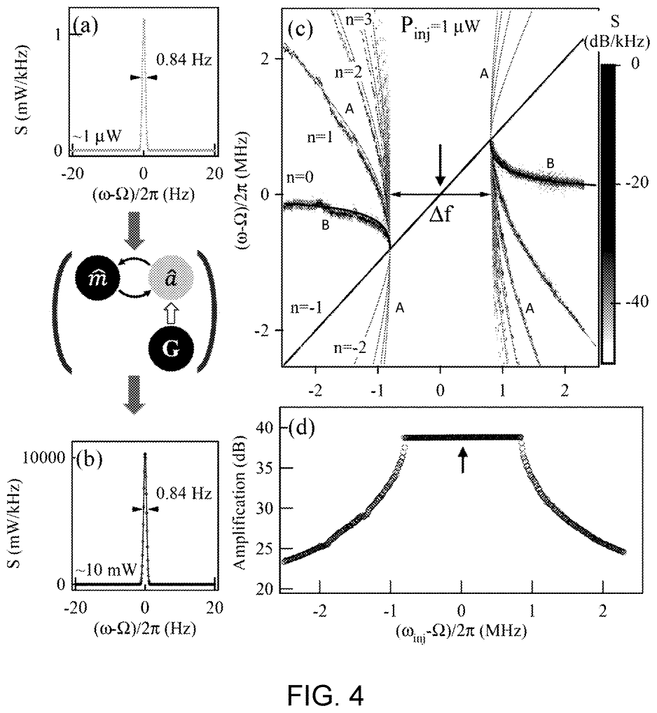

Finally, the capability of the GDP for coherently amplifying weak microwave signals was demonstrated. Using a signal generator, the weak signal (about 1 μW with 1.5×10¹⁰ photons) was injected into the GDP at the frequency ωᵢₙⱼ=2π=Ω/2π3.594 GHz. As shown in FIG. 4(a), the injected signal had an ultrahigh quality (FWHM of 0.84 Hz). With the injected weak signal, measurement was made of the output power spectral density S(f) of the photons emitted by the GDP. As shown in FIG. 4(b), the GDP amplified the input power by 4 orders of magnitude without undermining the ultrahigh quality of the input signal.

Consideration was made as to why the GDP, with an intrinsic emission FWHM of about 360 Hz, could coherently amplify the signal of the FWHM of 0.84 Hz so well. To clarify the mechanism, study was made of S(f) by systematically changing ωᵢₙⱼ. The measured S(f) mapping is plotted in FIG. 4(c), where the solid curves were calculated using Adler's classical theory [57] describing the locking phenomena of oscillators [37]. It was revealed that, as an auto-oscillator, the GDP can be phase locked by the weak signal via the injection locking mechanism [57]. At |ωᵢₙⱼ−Ω|/2π>0.8 MHz the wave mixing between the injected signal and the GDP emission produces a frequency comb with sideband oscillations. When ωᵢₙⱼ approaches Ω, the injected signal is amplified, so that all sideband oscillations are suppressed and the frequency of the GDP emission is pulled toward the injection tone. Within the injection locking bandwidth of Δf=1.6 MHz, the GDP enables about 40 dB coherent amplification, as shown in FIG. 4(d). Such a mode-selective amplification boosts the GDP's performance as a gain-driven coherent photon source, enhancing its emission quality factor to exceed 10⁹. The superb emission and amplification performance can be further improved by utilizing the flexible controllability of the cavity magnonics platform. For example, the bandwidth can be easily improved by using frequency-tunable planar cavities.

In summary, exploration was made of the physics of a gain-driven polariton.

Contrary to conventional polaritons formed in dissipative systems, here, the light-matter interaction is activated by an amplified electromagnetic field and stabilized by nonlinear damping. A GDP at microwave frequencies is created by incorporating the gain mechanism into the cavity magnonics platform. First, the transmission spectra of GDP are measured, revealing intriguing effects such as the initial condition dependent phase singularity and spontaneous mode selection that governs magnon-photon synchronization. Then, the photon emission of the GDP is studied by analyzing the photon statistics, demonstrating the gain-sustained phase and amplitude coherence. By using the injection locking technique, the emission linewidth of the GDP is optimized to below 1 Hz, exceeding many state-of-the-art masers. This work opens new horizons for exploring gain-driven light-matter interaction. The polariton auto-oscillation disclosed herein may broadly impact the study of synchronization, frequency combs, on-chip masers, and chaotic behaviors in light-matter interactions.

### CITED REFERENCES FOR PRECEDING CONTENT

[1] J. O. Artman and P. E. Tannenwald, Phys. Rev. 91, 1014 (1953).
[2] Ö. O. Soykal and M. E. Flatté, Phys. Rev. Lett. 104, 077202 (2010)
[3] H. Huebl, C. W. Zollitsch, J. Lotze, F. Hocke, M. Greifenstein, A. Marx, R. Gross, and S. T. B. Goennenwein, Phys. Rev. Lett. 111, 127003 (2013).
[4] Y. Tabuchi, S. Ishino, T. Ishikawa, R. Yamazaki, K. Usami, and Y. Nakamura, Phys. Rev. Lett. 113, 083603 (2014).
[5] X. Zhang, C.-L. Zou, L. Jiang, and H. X. Tang, Phys. Rev. Lett. 113, 156401 (2014).
[6] L. Bai, M. Harder, Y. P. Chen, X. Fan, J. Q. Xiao, and C.-M. Hu, Phys. Rev. Lett. 114, 227201 (2015).
[7] B. Zare Rameshti, S. Viola Kusminskiy, J. A. Haigh, K. Usami, D. Lachance-Quirion, Y. Nakamura, C.-M. Hu, H. X. Tang, G. E. Bauer, and Y. M. Blanter, Phys. Rep. 979, 1 (2022).
[8] D. Lachance-Quirion, Y. Tabuchi, A. Gloppe, K. Usami, and Y. Nakamura, Appl. Phys. Express 12, 070101 (2019).
[9] Z. Zhang, M. O. Scully, and G. S. Agarwal, Phys. Rev. Res. 1, 023021 (2019).
[10] A. A. Clerk, K. W. Lehnert, P. Bertet, J. R. Petta, and Y. Nakamura, Nat. Phys. 16, 257 (2020).
[11] X. Zhang, C. L. Zou, L. Jiang, and H. X. Tang, Sci. Adv. 2, e1501286 (2016).
[12] A. Osada, R. Hisatomi, A. Noguchi, Y. Tabuchi, R. Yamazaki, K. Usami, M. Sadgrove, R. Yalla, M. Nomura, and Y. Nakamura, Phys. Rev. Lett. 116, 223601 (2016).
[13] C. A. Potts, E. Varga, V. A. S. V. Bittencourt, S. V. Kusminskiy, and J. P. Davis, Phys. Rev. X 11, 031053 (2021).
[14] X. Zhang, C.-L. Zou, N. Zhu, F. Marquardt, L. Jiang, and H. X. Tang, Nat. Commun. 6, 8914 (2015).
[15] R.-C. Shen, Y.-P. Wang, J. Li, S.-Y. Zhu, G. S. Agarwal, and J. Q. You, Phys. Rev. Lett. 127, 183202 (2021).
[16] L. Bai, M. Harder, P. Hyde, Z. Zhang, C.-M. Hu, Y. P. Chen, and J. Q. Xiao, Phys. Rev. Lett. 118, 217201 (2017).
[17] D. Lachance-Quirion, S. P. Wolski, Y. Tabuchi, S. Kono, K. Usami, and Y. Nakamura, Science 367, 425 (2020).
[18] J. A. Haigh, A. Nunnenkamp, A. J. Ramsay, and A. J. Ferguson, Phys. Rev. Lett. 117, 133602 (2016).
[19] Y.-P. Wang, G.-Q. Zhang, D. Zhang, T.-F. Li, C.-M. Hu, and J. Q. You, Phys. Rev. Lett. 120, 057202 (2018).
[20] M. Harder, Y. Yang, B. M. Yao, C. H. Yu, J. W. Rao, Y. S. Gui, R. L. Stamps, and C.-M. Hu, Phys. Rev. Lett. 121, 137203 (2018).
[21] B. Bhoi, B. Kim, S.-H. Jang, J. Kim, J. Yang, Y.-J. Cho, and S.-K. Kim, Phys. Rev. B 99, 134426 (2019).
[22] I. Boventer, M. Kläui, R. Macedo, and M. Weides, New J. Phys. 21, 125001 (2019).
[23] D. Zhang, X.-Q. Luo, Y.-P. Wang, T.-F. Li, and J. Q. You, Nat. Commun. 8, 1368 (2017).
[24] B. M. Yao, Y. S. Gui, J. W. Rao, S. Kaur, X. S. Chen, W. Lu, Y. Xiao, H. Guo, K. P. Marzlin, and C.-M. Hu, Nat. Commun. 8, 1 (2017).
[25] J. Xu, C. Zhong, X. Han, D. Jin, L. Jiang, and X. Zhang, Phys. Rev. Lett. 125, 237201 (2020).
[26] Y.-P. Wang, J. W. Rao, Y. Yang, P.-C. Xu, Y. S. Gui, B. M. Yao, J. Q. You, and C.-M. Hu, Phys. Rev. Lett. 123, 127202 (2019).
[27] Y. Yang, Y.-P. Wang, J. W. Rao, Y. S. Gui, B. M. Yao, W. Lu, and C.-M. Hu, Phys. Rev. Lett. 125, 147202 (2020).
[28] H. Deng, G. Weihs, C. Santori, J. Bloch, and Y. Yamamoto, Science 298, 199 (2002).
[29] J. Kasprzak, M. Richard, S. Kundermann, A. Baas, P. Jeambrun, J. M. J. Keeling, F. M. Marchetti, M. H. Szymańska, R. André, J. L. Staehli, V. Savona, P. B. Littlewood, B. Deveaud, and L. S. Dang, Nature (London) 443, 409 (2006).
[30] H. Deng, H. Haug, and Y. Yamamoto, Rev. Mod. Phys. 82, 1489 (2010).
[31] C. Schneider, A. Rahimi-Iman, N. Y. Kim, J. Fischer, I. G. Savenko, M. Amthor, M. Lermer, A. Wolf, L. Worschech V. D. Kulakovskii, I. A. Shelykh, M. Kamp, S. Reitzenstein, A. Forchel, Y. Yamamoto, and S. Höfling, Nature (London) 497, 348 (2013).
[32] J. T. Hou, P. Zhang, and L. Liu, Phys. Rev. Appl. 16, 034034 (2021).
[33] B. van der Pol, Radio Rev. 1, 701 (1920).
[34] B. van der Pol, Philos. Mag. 2, 978 (1926).
[35] T. E. Lee and H. R. Sadeghpour, Phys. Rev. Lett. 111, 234101 (2013).
[36] S. Dutta and N. R. Cooper, Phys. Rev. Lett. 123, 250401 (2019).
[37] See below “Supplemental Theory & Experimental Details”, which also cites Refs. [38-51]
[38] L. D. Landau and E. M. Lifshitz, Mechanics, 3rd ed. (Pergamon Press, Oxford, 1976).
[39] L. Gilles and P. L. Knight, Phys. Rev. A 48, 1582 (1993).
[40] N. Minorsky, Nonlinear Oscillations (Krieger Publishing Company, Huntington, NY, 1974).
[41] J. W. Rao, Y. P. Wang, Y. Yang, T. Yu, Y. S. Gui, X. L. Fan, D. S. Xue, and C.-M. Hu, Phys. Rev. B 101, 064404 (2020).
[42] A. A. Clerk, M. H. Devoret, S. M. Girvin, Florian Marquardt, and R. J. Schoelkopf, Rev. Mod. Phys. 82, 1155 (2010).
[43] M. Armand, Proc. IEEE 57, 798 (1969).
[44] Y.-Y. Liu, J. Stehlik, M. J. Gullans, J. M. Taylor, and J. R. Petta, Phys. Rev. A 92, 053802 (2015).
[45] D. M. Pozar, Microwave Engineering, 4th ed. (John Wiley & Sons, New York, 1998).
[46] R. Loudon, The Quantum Theory of Light, 2nd Ed. (Clarendon, Oxford, 1983).
[47] J. D. Breeze, E. Salvadori, J. Sathian, N. M. Alford, and C. W. M. Kay, Nature (London) 555, 493 (2018).
[48] H. Kraus, V. a. Soltamov, D. Riedel, S. Vath, F. Fuchs, A. Sperlich, P. G. Baranov, V. Dyakonov, and G. V. Astakhov, Nat. Phys. 10, 157 (2014).
[49] M. Oxborrow, J. D. Breeze, and N. M. Alford, Nature (London) 488, 353 (2012).
[50] M. Nick and A. Mortazawi, IEEE Trans. Microw. Theory Techn. 58, 1133 (2010).
[51] M. Nick, Ph.D. dissertation, Department Electrical Engineering, Michigan University, Ann Arbor, MI, 2011.
[52] S. I. Klselev, J. C. Sankey, I. N. Krivorotov, N. C. Emley, R. J. Schoelkopf, R. A. Buhrman, and D. C. Ralph, Nature (London) 425, 380 (2003).
[53] S. Kaka, M. R. Pufall, W. H. Rippard, T. J. Silva, S. E. Russek, and J. A. Katine, Nature (London) 437, 389 (2005).
[54] A. M. Deac, A. Fukushima, H. Kubota, H. Maehara, Y. Suzuki, S. Yuasa, Y. Nagamine, K. Tsunekawa, D. D. Djayaprawira, and N. Watanabe, Nat. Phys. 4, 803 (2008).
[55] Y.-Y. Liu, J. Stehlik, C. Eichler, M. J. Gullans, J. M. Taylor, and J. R. Petta, Science 347, 285 (2015).
[56] M. C. Cassidy, A. Bruno, S. Rubbert, M. Irfan, J. Kammhuber, R. N. Schouten, A. R. Akhmerov, and L. P. Kouwenhoven, Science 355, 939 (2017).
[57] R. Adler, Proc. IRE 34, 351 (1946).

### Supplemental Theory & Experimentation Details

In supplement to the details given above, further supportive theory and constructive detail in enabling support of the claimed invention are given as follows.

### S1. Theory of the Gain-Driven Polariton

### S1.1. Damped-Driven Oscillator

We start our theoretical analysis from a damped-driven oscillator consisting of a mass m and a driving force F with an angular frequency ω. The solution of the oscillator is more conveniently found in the complex form of the equation of motion.¹ Following the e^{-iωt} convention, we have

$$\ddot{x} + 2 λ \dot{x} + {w}_{c}^{2} x = ( F / m ) exp ( - i ω t ) , \qquad ( S2 )$$

where ω_{c} corresponds to the natural resonance frequency of the oscillator and λ denotes the damping parameter. Using textbook knowledge, we seek a particular solution in the form x=B exp(−iωt) exp(iψ) (B is a real number) and obtain

$$B = \frac{F / m}{\sqrt{{( {ω}^{2} - {ω}_{c}^{2} )}^{2} + 4 {ω}^{2} {λ}^{2}}} , \qquad ( S2a )$$

$$ψ = Arg ( - {ω}^{2} + {ω}_{c}^{2} + 2 i λω ) , \qquad ( S2b )$$

where ψ is the phase lag between the response and the driving force, and the function Arg(z) denotes the principal value of the argument of a complex number z. Near the natural resonance frequency (ω~ω_{c}), the spectrum

$${B}^{2} ( ω ) \approx \frac{{F}^{2}}{4 {ω}_{c}^{2} {m}^{2}} \frac{1}{{( ω - {ω}_{c} )}^{2} + {λ}^{2}}$$

follows a Lorentzian lineshape and the phase becomes ψ~Arg(−ω+ω+iλ). Far from resonance on the side ω<ω_{c}, the relative phase between the driving force and the response ψ→0 on the side ω>ω_{c}, ω_{c}, ψ→180°. For λ<<ω_{c} a rapid phase change from zero to 180° takes place in the vicinity of ω_{c}, within a few λ in width, and ψ passes through 90° when ω=ω_{c}. The dashed line in Fig. S1(a) [same as that in FIG. 1(f)] is the phase evolution of the driven oscillator calculated according to Eq. (S2b) with ω_{c}/2π=3.6 GHz and λ/2π=0.9 MHz.

### S1.2. Cavity Magnon Polariton in a Quasi-Closed System

In a quasi-closed system, such as placing a magnetic sample inside a microwave cavity, the spatial overlap between the microwave field and the magnon mode leads to the energy exchange between two subsystems, producing coherent coupling characterized by a coupling strength J (a positive number in a coherent coupled cavity-magnon system).² The hybridization of the cavity and magnon modes introduces new quasiparticles named cavity magnon polaritons (CMPs). In the rotating wave approximation, an approximation used in atom optics and magnetic resonance to neglect the rapid oscillation in a Hamiltonian, the dynamics of such a quasi-closed system can be described by an effective non-Hermitian Hamiltonian

Ĥ_{cmp}=h\tilde{ω}_{c}â^{†}â+h\tilde{ω}\hat{m}^{†}\hat{m}+hJ(â^{†}\hat{m}+\hat{m}^{†}â) (S3)

where â^{†} (â) and \hat{m}^{†}(\hat{m}) represent the creation (annihilation) operators of the cavity photon and the magnon modes, respectively. The real and imaginary parts of complex frequencies \tilde{ω}_{c}=ω_{c}−iκ_{c} and \tilde{ω}ₘ=ωₘ−iκₘ are related to the experimentally observed resonance frequencies, ω_{c} of the cavity mode and ωₘ of the magnon mode, and their damping rates, κ_{c} and κₘ.

From Eq. (S3), the equations of motion are

$$\frac{d 〈 \hat{a} 〉}{dt} = - \frac{i}{ℏ} 〈 [ \hat{a} , {\hat{H}}_{cmp} ] 〉 = - i {\tilde{ω}}_{c} 〈 \hat{a} 〉 - iJ 〈 \hat{m} 〉 , \qquad ( S4a )$$

$$\frac{d 〈 \hat{m} 〉}{dt} = - \frac{i}{ℏ} 〈 [ \hat{m} , {\hat{H}}_{cmp} ] 〉 = - i {\tilde{ω}}_{m} 〈 \hat{m} 〉 - iJ 〈 \hat{a} 〉 , \qquad ( S4b )$$

which describe the coupling behavior of a quasi-closed cavity-magnon system. In the classical limit, where there are many photons and magnons, [symbol] â^{†}â [symbol] , [symbol] \hat{m}^{†}\hat{m} [symbol] >>1, one can replace the expectation values [symbol] [symbol] of the operators â and \hat{m} with scalar complex numbers a and m, denoting the coherent state.

The complex eigenfrequency of such a hybridized system \tilde{ω}_{±} is determined to be

$${\tilde{ω}}_{\pm } = {ω}_{\pm } - i {δω}_{\pm } = \frac{1}{2} [ {\tilde{ω}}_{c} + {\tilde{ω}}_{m} \pm \sqrt{{( {\tilde{ω}}_{c} - {\tilde{ω}}_{m} )}^{2} + 4 {J}^{2}} ] = {\tilde{ω}}_{c} + \tilde{Δ} / 2 \pm \tilde{Λ} , \qquad ( S5 )$$

Where the real part of \tilde{ω}_{±} represents the resonance frequency of the hybridized mode and the imaginary part for its linewidth with Ã=\tilde{ω}ₘ−\tilde{ω}_{c} and \tilde{Λ}=\sqrt{J²+(\tilde{Δ}/2)²}. Figure S1(b) shows the calculated CMP dispersion with κ_{c}=0, κₘ/2π=0.9 MHz and J/2π=6 MHz.

Accordingly, the coupling between microwave photons and magnons produces two CMP modes

\hat{p}_{±}=c_{±}â±c_{∓}\hat{m} (S6)

with the normalized state amplitude c_{±}=\sqrt{(\tilde{Λ}∓\tilde{Δ}/2)/2\tilde{Λ}}. In each coupled mode, the phase between the two subsystems is locked, expressed as

θ_{±}=Arg(±c₊/c_{∓})=Arg(−Δ/2±Λ)=Arg(\tilde{ω}_{±}−\tilde{ω}ₘ). (S7)

For a strongly coupled system (J>>κₘ, κ_{c}), because of ω₊>ωₘ [as shown in Fig. S1(c)], θ₊~0 and \hat{p}₊ represents the in-phase oscillation of the two subsystems; by contrast, θ₋~ 180° and \hat{p}₋ represents an anti-phase oscillation. Such a feature is highlighted as dotted lines in Fig. S1(a), which are the calculated θ_{±} based on Eq. (S7).

The free-running CMP modes are in general the superposition of p₊- and p₋-states. As an example, at zero detuning Δ=ωₘ−ω_{c}=0 with initial conditions of a(0)=a₀ and m(0)=0, we can solve Eq. (S4) and obtain

a(t)=a₀e^{(κ}^{_{c}}^{+κ}^{ₘ}^{)t/2}e^{-iω}^{_{c}}^{t} cos(Jt) (S8A)

m(t)=−ia₀e^{-(κ}^{_{c}}^{+κ}^{ₘ}^{)t/2}e^{-iω}^{_{c}}^{t} sin(Jt) (S8b)

which reveals a beating pattern with fast oscillations at a frequency ω_{c} modulated by the Rabi-like frequency J as shown in Fig. S1(e). The calculation parameters are ω_{c}/2π=3.6 GHz, κ_{c}=0, κₘ/2π=0.9 MHz and J/2π=6 MHz.

### S1.3. Van Der Pol Oscillator

The van der Pol oscillator³ is a non-conservative oscillator with non-linear damping in dynamics. Energy is dissipated at high amplitudes and generated at low amplitudes. As a result, there is a steady-state at which energy generation and dissipation balance. To model it, we can simply reform the complex frequency of the cavity mode in Eq. (S4a) as

\tilde{ω}_{c}=ω_{c}+i(G−κ_{c}−γ|a|²) (S9)

Besides the linear damping Kc, there are two additional types of dissipation: negative damping (G) and nonlinear damping (γ|a|²). In quantum analogues, these terms represent two dissipative processes: the oscillator gains one photon at a rate G [symbol] ââ^{†} [symbol] and loses two photons at a rate γ [symbol] â^{†2}â² [symbol] .^{4,5} Its microscopic model includes the environmental photon bath, and an effective Hamiltonian will be presented in Sec. S1.6. For a bare van der Pol cavity, the competition between the gain and the nonlinear damping leads to a steady-state solution oscillating at the natural frequency ω_{c}. Taking a(t)= [symbol] â(t) [symbol] =A(t)e^{-iω}^{_{c}}^{t} and substituting it into Eq. (S4a) with J=0 and the initial condition A(0)=a₀~0, the time evolution of the bare cavity amplitude is

$$A ( t ) = \frac{{a}_{0} \sqrt{G - {κ}_{c}}}{\sqrt{G - {κ}_{c} - γ {a}_{0}^{2} + γ {a}_{0}^{2} {e}^{2 ( G - {κ}_{c} ) t}}} {e}^{( G - {κ}_{c} ) t} . \qquad ( S 10 )$$

If G−κ_{c}>0, the oscillating amplitude A exponentially grows with a rate of G-κ_{c}, meanwhile, the nonlinear damping rate γA² also exponentially grows, but with twice the speed 2(G−κ_{c}), eventually making A saturated, leading to the steady-state

$${A}_{c} = \sqrt{\frac{G - {κ}_{c}}{γ}}$$

regardless of the initial condition. As shown in Fig. S1(d), the oscillation amplitude of a van der Pol oscillator saturates rapidly (0.1 μs). The calculation parameters are ω_{c}/2π=3.6 GHz, (G κ_{c})/2π=25 MHz, and γ/2π=2.6×10⁻¹² MHz. The extremely small value of the parameter γ makes it essentially irrelevant to the dynamic coupling process, such as phase singularity discussed in Sec. S1.5. Its primary effect is to set the amplitude of the steady state, which can be experimentally estimated according to the photon number discussed in Sec. S3.7.

### S1.4. Gain-Driven Polariton in a Closed System

A steady-state also exists when the van der Pol oscillator is coupled with a magnon mode, which is the gain-driven polariton (GDP). In this section, we demonstrate the distinguishing features of a GDP system compared to a conventional CMP system starting from Eq. (S4) with \tilde{ω}_{c}=ω_{c}+i(G−κ_{c}−γ|a|²)

Since the initial conditions of the studied GDP system play a crucial role, as our experimental results demonstrate, usually, this nonlinear system cannot be solved explicitly and must be in numerical schemes to approximate the solution accurately. Here, one can take the solution a(t)=A(t)e^{iθa} (t)e^{-iΩt} and m(t)=M(t)e^{iθm}(t)e^{-iΩt} to separate fast oscillatory Ω-terms from other slow ones, where Ω is the GDP resonance frequency. Using the method of averaging⁶, which eliminates fast oscillations through averaging the variables over the oscillation period (2π/Ω), the qualitative behaviour of the real variables A(t), M(t), and θ(t)[=θₐ(t)−θₘ(t)] follows as

$$\frac{dA}{dt} = ( G - {κ}_{c} - γ {A}^{2} ) A - J sin ( θ ) M , \qquad ( S 11 a )$$

$$\frac{dM}{dt} = - {κ}_{m} M + J sin ( θ ) A , \qquad ( S 11 b )$$

$$\frac{d θ}{dt} = Δ + J cos ( θ ) ( \frac{A}{M} - \frac{M}{A} ) . \qquad ( S 11 c )$$

Figure S1(f) plots the time evolution of Re[a(t)] at zero detuning, where the system is excited with initial conditions A(0)~0 and M(0)~0. The simulation parameters are ω_{c}/2π=3.6 GHz, (G−κ_{c})/2π=25 MHz, γ/2π=2.6×10⁻¹² MHz, κₘ/2π=0.9 MHz and J/2π=6 MHz. The system becomes stable with A=M=0.98A_{c} and θ=8.6° after a few 10 μs, and a single frequency oscillation with Ω/2π=3.6059 GHz is produced. Varying the detuning Δ, we can plot the evolution of θ and Ω as the greytone solid line and circles in Figs. S1(a) and S1(c), respectively.

### S1.5. Phase Singularity of a Gain-Driven Polariton

As shown in Fig. S1(a), the characteristic phase of the GDP switches abruptly from θ~0 to θ~180° at a critical detuning Δ_{c}, emerging as a phase singularity of the system. Under no-memory setting excitation [A(0)~0 and M(0)~0] such a phase transition always occurs at Δ_{c}=0 which resembles the phase profile of a driven oscillator when the damping parameter λ is zero.

One can understand this effect based on the CMP eigenvector [Eq. (S6)] and its phase [Eq. (S7)]. When the amplitude A becomes stable in a GDP system, the complex frequency of the cavity mode defined in Eq. (S9) is a constant, and the equation of motion leads to a standard 2×2 matrix. One can still use Eq. (S5) to calculate the complex eigenfrequency and just need to input the saturated A value. Figures. S2(a) and S2(b) plot the deduced eigenfrequency and its damping parameter as a function of detuning, respectively. For a steady-state, its damping parameter must be zero and thus the steady GDP state (greytone thickened linespans and the interconnection therebetween) switches abruptly from the ω₊-state to ω₋-state, accompanied with a phase transition from θ₊~0 to θ₋~180° [Fig. S2(c)]. From the viewpoint of synchronization, magnons and photons in the GDP system are changed from in-phase synchronization to anti-phase synchronization when they cross this phase singularity, which can be summarized as

θ=Arg(Ω−\tilde{ω}ₘ) (S12)

Based on the CMP eigenvector \hat{p}_{±}=c_{±}â±c_{∓}\hat{m}, we have also constructed the GDP steady-state with [symbol] \hat{P}_{±} [symbol] =P_{±}e^{-iΩt}. In this case, the amplitude is

$${P}_{\pm } = {c}_{\pm } A \pm {c}_{∓} {e}^{- i θ} M = \frac{{\tilde{ω}}_{\pm } - {\tilde{ω}}_{m}}{\sqrt{{( {\tilde{ω}}_{\pm } - {\tilde{ω}}_{m} )}^{2} + {J}^{2}}} A + \frac{J}{\sqrt{{( {\tilde{ω}}_{\pm } - {\tilde{ω}}_{m} )}^{2} + {J}^{2}}} {e}^{- i θ} M . \qquad ( S 13 )$$

Along with the phase singularity, the GDP forms the spontaneous mode-selection feature as shown in Figs. S2(a) and S2(d):

|P₋|=0, |P₊|>0, Ω≃ω₊, for Δ<Δ_{c} (S14A)

|P₊|=0,|P₋|>0, Ω≃ω₋, for Δ>Δ_{c} (S14b)

### S1.6. Microscopic Model of Gain-Driven Polariton

Compared with the CMP system in a quasi-closed system, which is described as the effective Hamiltonian in Eq. (S3), the dynamical evolution of GDP states involves the interaction with the environmental bath. There are two other dissipative processes: one-photon gain and two-photon absorption, which are the quantum analogues of negative damping and nonlinear damping in Eq. (S9).^{4,5} In this section, we consider a model by including these two processes and build an effective Hamiltonian. This simplest model can serve as a prototypical model and provide working equations for understanding and analyzing vital experimental features, such as hysteresis in a coupled system with the van der Pol oscillator. As will be explained, the key results from the model are consistent with the closed cavity model and in agreement with the experiments under two different conditions. Including the environmental photon bath, the total Hamiltonian may read as

$$\hat{H} = {\hat{H}}_{0} + {\hat{H}}_{b} + {\hat{H}}_{int} , \qquad ( S 15 A )$$

$${\hat{H}}_{0} = ℏ {\tilde{ω}}_{c} {\hat{a}}^{†} \hat{a} + ℏ {\tilde{ω}}_{m} {\hat{m}}^{†} \hat{m} + ℏ J ( {a}^{†} \hat{m} + {\hat{m}}^{†} \hat{a} ) . \qquad ( S 15 B )$$

$${H}_{b} = \int ℏ {ω}_{k} {\hat{p}}_{k}^{†} {\hat{p}}_{k} dk , \qquad ( S 15 C )$$

$${\hat{H}}_{int} = \int ℏ [ i {λ}_{c} ( {\hat{a}}^{†} {\hat{p}}_{k} + \hat{a} {\hat{p}}_{k}^{†} ) + μ ( {\hat{a}}^{† 2} {\hat{p}}_{k} + {\hat{a}}^{2} {\hat{p}}_{k}^{†} ) + i {λ}_{m} {e}^{i φ} ( {\hat{p}}_{k} {\hat{m}}^{†} - {\hat{p}}_{k}^{†} \hat{m} ) ] dk . \qquad ( S 15 D )$$

where Ĥ₀ denotes the direct interaction between the cavity photon and the magnon due to field overlap, same as Eq. (S3). Ĥ_{b} describes the photon bath, p̅ₖ is the boson annihilation operator of the traveling photon with (\hat{p}ₖ, \hat{p}_{k′})=δ(k−k′), and ωₖ is its frequency.

The cavity photon and the magnon interact with a common traveling electromagnetic field, summarized as Hint. The first term inside the brackets of the Eq. (S15d) is the linear interaction between the cavity photon and the gain device. It produces a negative damping rate of the cavity photon mode related to the linear gain of the van der Pol oscillator. The second term represents the nonlinear damping caused by higher-order harmonic generation, and the third term leads to radiative damping of the magnon mode⁷. λ_{c}(λₘ) is the coupling strength of the cavity (magnon) mode with traveling photons, and φ is the phase lag of the photon traveling from one mode to another.

Following a standard procedure^{7,8}, the traveling photon \hat{p}ₖ is solved as

$${\hat{p}}_{k} = {\int }_{{t}_{0}}^{t} ( {λ}_{c} \hat{a} - i μ {\hat{a}}^{2} - {λ}_{m} {e}^{i φ} \hat{m} ) {e}^{- i {ω}_{k} ( t - {t}^{′} )} {dt}^{′} . \qquad ( S 16 )$$

Substituting it into the equation of motion and focusing on the harmonic generation, in the classical limit, the corresponding equations of motion for a= [symbol] â [symbol] and m= [symbol] \hat{m} [symbol] are

$$\frac{da}{dt} = - i ( {ω}_{c} + i {πλ}_{c}^{2} - i {κ}_{c} - 2 i {πμ}^{2} {\vert a \vert}^{2} ) a - i ( J - i {πλ}_{c} {λ}_{m} {e}^{i φ} ) m , \qquad ( S 17 a )$$

$$\frac{dm}{dt} = - i ( {ω}_{m} - i {κ}_{m} - i {πλ}_{m}^{2} {e}^{2 i φ} ) m - i ( J + i {πλ}_{c} {λ}_{m} {e}^{i φ} ) a . \qquad ( S 17 b )$$

We can define G=πλ² to describe the dynamic process of gaining one photon, γ=2πμ² the process of losing two photons, and Γ=πλ_{c}λₘ as based-mediated indirect coupling between microwave photons and magnons; hence, the radiative damping rate due to the interaction between traveling photons and magnons is πλ²=Γ²/G. Introducing the complex frequencies \tilde{ω}_{c}=ω_{c}+i(G−κ_{c}−γ|a|²) [Eq. (2) in the Main Text] and

$${\tilde{ω}}_{m} = {ω}_{m} - i ( {κ}_{m} + \frac{{Γ}^{2}}{G} {e}^{2 i φ} ) ,$$

we can simplify equations above as

$$\frac{da}{dt} = - i {\tilde{ω}}_{c} a - i ( J - i Γ {e}^{i φ} ) m , \qquad ( S 18 a )$$

$$\frac{dm}{dt} = - i {\tilde{ω}}_{m} m - i ( J - i Γ {e}^{i φ} ) a , \qquad ( S 18 b )$$

When the amplitude A becomes saturated, the complex frequency of the cavity mode defined in Eq. (S9) is constant, and the equation of motion Eq. (S18) leads to a standard 2×2 matrix, where the complex eigenfrequency is

$${\tilde{ω}}_{\pm } = \frac{1}{2} [ {\tilde{ω}}_{c} + {\tilde{ω}}_{m} \pm \sqrt{{( {\tilde{ω}}_{c} + {\tilde{ω}}_{m} )}^{2} + 4 ( {J}^{2} + {Γ}^{2} {e}^{2 i φ} )} ] . \qquad ( S 19 )$$

The deduced CMP eigenvector

$${\hat{p}}_{\pm } = \frac{{\tilde{ω}}_{\pm } - {\tilde{ω}}_{m}}{\sqrt{{( {\tilde{ω}}_{\pm } - {\tilde{ω}}_{m} )}^{2} + ( J + i Γ {e}^{{i φ )}^{2}}}} \hat{a} + \frac{J}{\sqrt{{( {\tilde{ω}}_{\pm } - {\tilde{ω}}_{m} )}^{2} + ( J + i Γ {e}^{{i φ )}^{2}}}} \hat{m}$$

indicates that the locked phase between a and m is

θ_{±}=Arg(\tilde{ω}_{±}−\tilde{ω}ₘ)−Arg(J+Γe^{iφ}) (S20)

In addition to the first term, which is the same as Eq. (S7), the second term Arg(J+iΓe^{iφ}) on the right side is solely due to the complex coupling strength between two sub-systems, which is a constant. One can separate its contribution by taking the solution a(t)=A(t)e^{iθa}(t)e^{-iΩt} and m(t)=M(t)e^{iθm}(t)e^{iθ}Γ e^{-iΩt} and numerically solve Eq. (S18). This modification does not affect the previous conclusions in a closed system (Sec. S1.4 and Sec. S1.5), because J is a pure real number and θ_{Γ}=0. Using the method of averaging to eliminate the fast oscillations, the time evolution of A(t), M(t), and θ(t)[=θₐ(t)−θₘ(t)] can be expressed as

$$\frac{da}{dt} = ( G - {κ}_{c} - γ {A}^{2} ) A - [ Γ cos ( φ - θ + {θ}_{Γ} ) + J sin ( θ - {θ}_{Γ} ) ] M , \qquad ( S 21 a )$$

$$\frac{dM}{dt} = ( G - {κ}_{m} M + [ Γ cos ( φ - θ + {θ}_{Γ} ) + J sin ( θ - {θ}_{Γ} ) ] A , \qquad ( S 21 b )$$

$$\frac{d θ}{dt} = Δ + [ - Γ sin ( φ + θ - {θ}_{Γ} ) + J cos ( θ - {θ}_{T} ) ] \frac{A}{M} - [ Γ sin ( φ - θ + {θ}_{Γ} ) + J sin ( θ - {θ}_{Γ} ) ] \frac{M}{A} . \qquad ( S 21 c )$$

We have numerically solved Eq. (S21), and the results are summarized in Fig. S3. The device parameters used are ω_{c}/2π=3.588 GHz, (G κ_{c})/2π=170 MHz, γ/2π=2.6×10⁻¹² MHz, J/2π=4.5 MHz, ΓT/2π=6.1 MHz, φ=37°, and κₘ/2π=0.9 MHz, which were deduced from the calibration processes discussed in Sec. S3.

Figures S3(a) and S3(b) plot the deduced eigenfrequency and its damping parameter as a function of detuning, based on the real and imaginary parts of \tilde{ω}_{±}. The damping parameter of a steady-state must be zero and thus the steady GDP state [greytoned thickened linespans and interconnection thereof in Fig. S3(a)] switches abruptly from the ω₊-state to ω₋-state, accompanied with a phase jump [Fig. S3(c)]. Same as that in a closed system, the GDP phase θ in an open system can also be summarized as θ=Arg(Ω−\tilde{ω}ₘ), which highlights the phase-jump occurring between 0 and 180° when Ω toggles between below and above ωₘ near the critical detuning Δ_{c}.

We can further construct the GDP steady-state with [symbol] \hat{P}_{±} [symbol] =P_{±}e^{-iΩt} in a more general case, where the amplitude becomes

$${p}_{\pm } = \frac{{\tilde{ω}}_{\pm } - {\tilde{ω}}_{m}}{{d}_{\pm }} A + \frac{J - i Γ {e}^{i φ}}{{d}_{\pm }} {e}^{- i ( θ - {θ}_{Γ} )} M , \qquad ( S 22 )$$

with the normalized factor d_{±}=\sqrt{(\tilde{ω}_{±}−\tilde{ω}ₘ)²+(J−iΓe^{iφ})²} When Γ=0, which leads to θ_{Γ}=0, Eq. (S22) turns back to Eq. (S13).

As shown in Figs. S3(a) and S3(d), the GDP forms the spontaneous mode-selection feature along with the phase singularity, which can be highlighted as

|P₋|=0, |P₊|>0, Ωδω₊, for Δ<Δ_{c},

|P₊|=0, |P₋|>0, Ω≃ω₋, for Δ>Δ_{c}

Such a key feature obtained from the open cavity model is consistent with the closed system summarized in Eq. (S14).

To compare the experimental observation, we fix with A(0)=A_{c}=\sqrt{(G−κ_{c})/γ}=8.1×10⁶ and vary M(0) in a wide range. By solving Eq. (S21) numerically, we obtain the diagram of the phase-jump, as shown in Fig. S4(a). In the case of no-memory setting excitation, M(0) 0, the jump appears at Δ/2π=18 MHz; however, the phase transition can occur at a higher detuning Δ/2π=40 MHz if M(0)>>A_{c}.

Figure S4(b) shows the simulated dispersion for up-sweep and down-sweep detuning, in which the initial conditions are the previous numerical solutions at t→+∞. As expected, a hysteresis GDP dispersion is obtained, where the GDP can be more magnon-like if the magnon oscillating amplitude gradually increases by up-sweep the detuning (controlled by an external magnetic field in experimental measurements).

### S1.7. Forced GDP and Injection Locking Effect

If an external harmonic driving force F exp(−iωᵢₙⱼt) is applied to the microwave cavity in a GDP system, the equations of motion becomes

$$\frac{da}{dt} = - i {\tilde{ω}}_{c} a - i ( J - i Γ {e}^{i φ} ) m + F exp ( - i {ω}_{inj} t ) , \qquad ( S 24 a )$$

$$\frac{dm}{dt} = - i {\tilde{ω}}_{m} m - i ( J + i Γ {e}^{i φ} ) a . \qquad ( S 24 b )$$

where F=κ\sqrt{Pᵢₙⱼ}, Pᵢₙⱼ is the injected microwave power and κ is the coupling strength between the input port and microwave cavity. For the simplest case, we will first look for a solution to the equations of motion that oscillates with the same angular frequency, ωᵢₙⱼ, as the driving force. The steady solution of Eq. (S24) leads to

$${ω}_{inj} - {ω}_{c} - \frac{[ {J}^{2} + {Γ}^{2} cos ( 2 φ ) ] ( {ω}_{inj} - {ω}_{m} ) + {κ}_{m} {Γ}^{2} sin ( 2 φ )}{{( {ω}_{inj} - {ω}_{m} )}^{2} + {κ}_{m}^{2}} - \frac{F}{A} sin ( {θ}_{a} ) = 0. \qquad ( S 25 )$$

When the driving force F<<A and the driving frequency is close to the free-running GDP frequency, we can define ωᵢₙⱼ=Ω+ε, where |ε|<<Ω, and use the Taylor series approximation to find the solution of the above equation

$$ε \approx {[ 1 + \frac{{J}^{2} + {Γ}^{2} cos ( 2 φ )}{{( Ω - {ω}_{m} )}^{2}} ]}^{- 1} \frac{κ \sqrt{{P}_{inj}}}{A} sin ( {θ}_{a} ) . \qquad ( S26 )$$

Equation (S26) describes the injection locking effect in a GDP system, in which the photon emission can be frequency-locked by the injection beam in a frequency range Δf=[ε(θₐ=π/2)ε(θₐ=−π/2)]2π. Similar to the conventional injection locking effect⁹, the bandwidth of injection locking is proportional to the coupling strength (κ) and the field strength (\sqrt{Pᵢₙⱼ}) of the injected signal, and inversely proportional to the GDP field strength (A). In addition, the coupling phenomena introduces additional controlling parameters (inside square brackets) of Eq. (S26), leading to injection locking that is also strongly dependent on the coupling parameters (J and I) and frequency detuning (A).

Outside the locking range, while still dθ/dt=0 for the steady-state, θₐ(t) and θₘ(t) become a function of time, which makes it not easy to obtain a general analytical solution to derive the driven GDP frequency (=ωᵢₙⱼ−dθₐ/dt) and sideband frequencies according to Eq. (S24). Alternatively, we can ignore the detailed dynamic process of the GDP generation and simplify the problem as a GDP emission disturbed by a second oscillator operating at a nearby frequency. According to the discussion in Adler's original work⁹, the angular frequency of the pulled emission signal and the n-th harmonics are given by^{10,11}

ωₙ=ωᵢₙⱼ+(n+1)ω_{b} (S27)

with a beating angular frequency

$${ω}_{b} = ( Ω - {ω}_{inj} ) \sqrt{1 - {( \frac{ε}{Ω - {ω}_{inj}} )}^{2}} . \qquad ( S28 )$$

### S2. EXPERIMENTAL APPARATUS

A schematic diagram of the experimental apparatus is shown in Fig. S5. The microwave amplification is achieved by adding an active device (a bipolar junction transistor, BJT) at a common emitter configuration.¹² The emitter is grounded, the base-emitter junction is forward-biased, and the collector-emitter junction is based on a voltage V. A BJT acts as a negative resistance, where the bias current and voltage have an exponential relation. As summarized in Table I, a dozen devices with different cavity designs and substrates were measured at different YIG positions and biased voltage. In general, low dielectric loss substrates, such as RT/Duroid® 5870/5880 laminates, are well suited for fabricating high-frequency resonators and demonstrating the smallest linewidth of the amplified signal. The FR4 substrate, on the other hand, has significant mechanical strength and thus high stability for low-frequency resonators, making it an ideal device for characterizing device performances using diverse experimental settings. Aside from its compactness, the resonator structure has no significant effect on the device's performance.

In this context of the experimental apparatus, the device is based on design (a) in Table I and employs an FR4 substrate. A typical set of hysteresis GDP dispersion shows the comparison when varying the YIG height (h) to the substrate in Fig. S6. These features are generally the same as expected, although the hysteresis is more pronounced for large coupling strengths at small heights due to large field overlapping.

### S3. GDP DEVICE MEASUREMENT

This section provides detailed information on the device calibration and measurement. The results mainly include
1. S-parameter measurement using a vector network analyzer (VNA), which calibrates
   a. the magnon damping rate κₘ,
   b. the cavity damping rate κ_{c},
c. the coherent coupling strength J by setting the van der Pol oscillator near the threshold;
d. the device gain G, indirect coupling strength Γ, and the phase φ by fitting the up-sweep and down-sweep detuning measurement;
2. Power spectral density measurement using a signal analyzer (SA), which calibrates
   a. the photon number N of the emitted microwave;
   b. the nonlinear damping parameter γ of the van der Pol oscillator;
3. Time-domain measurement using a high-speed oscilloscope, which provides
   a. the photon statistics of the GDP emission;
   b. the coherence time Tc of the GDP emission.

### S3.1. Magnon Mode Calibration

The magnetic sample used is a 1-mm diameter YIG sphere mounted on a probe attached to an x-y-z stage, placed near the coupling port and about 3 mm above the cavity plane. The magnon mode is calibrated through the S-parameter measured by an N5230C VNA from Keysights Technologies. Here the YIG sample is excited through the cavity (at zero bias voltage) and locally detected by a tiny loop antenna (with a diameter of about 2 mm). Figure S7(a) shows a typical microwave transmission spectrum |S₂₁|²(ω) at μ₀H=138 mT. We believe this mode to be the Kittel mode because it has the maximum absorption and maximum coupling strength.

The experimental data (circles) is fitted by a complex Lorentzian function

$${\vert {S}_{21} ( ω ) \vert}^{2} ∝ {C}_{s} \frac{{κ}_{m}^{2}}{{( ω - {ω}_{m} )}^{2} + {κ}_{m}^{2}} + {C}_{as} \frac{{κ}_{m} ( ω - {ω}_{m} )}{{( ω - {ω}_{m} )}^{2} + {κ}_{m}^{2}} ,$$

where the small asymmetric part determined by Cₐₛ-term may be due to impedance mismatches within the measurement circuit. The fitting procedure gives the magnon resonance frequency ωₘ and the magnon damping rate κₘ.

As shown in Fig. S7(b), the magnon mode follows a linear dispersion, ωₘ=γₑμ₀(H+H_{A}), by varying the external magnetic field H within the frequency range of interest around the cavity mode. Here γₑ=2π×27.3 GHz/T is the effective gyromagnetic ratio, μ₀H_{A}=−6.2 mT is the effective magnetocrystalline anisotropy field and μ₀ is the permeability of vacuum. In the measured frequency range, the magnon damping rate κₘ/2π=0.90±0.05 MHz deduced from the lineshape fitting is not sensitive to ωₘ, as shown in Fig. S7(c).

### S3.2. Cavity Design and Calibration

The planar microwave cavity is fabricated from the conventional FR4 substrate. The relative permittivity of the substrate is 4.4 @ 1 GHz with a loss tangent of 0.03 @1 GHz. The substrate is 1.57 mm thick and covered by 17.5 μm copper layers on both sides. The microwave cavity is a half-wavelength transmission line resonator whose width matches 50Ω impedance. A voltage-controlled microwave amplifier is inserted to realize the gain. The input and output ports of the resonator are coupled to 50Ω transmission lines with characteristic rates κᵢₙ=κₒᵤₜ=κ/2.

As shown in Fig. S8, the microwave transmission of the bare cavity can be well-fitted according to

$${\vert {S}_{21} \vert}^{2} = \frac{{κ}^{2}}{{( ω - {ω}_{c} )}^{2} + {κ}_{c}^{2}} .$$

Here κ_{c}/2π=142 MHz is the resonator's total decay rate, including the extrinsic damping rate κ/2π=28 MHz and the intrinsic damping rate κᵢ/2π=114 MHz. The embedded microwave amplifier introduces additional losses in the gain-off-state. It significantly increases the designed intrinsic damping rate when compared at 20 MHz for a reference resonator without the amplifier. The bare resonance frequency ω_{c}/2π=3.57 GHz will slightly vary when turning on the bias voltage and the magnetic field.

### S3.3. Microwave Transmission of the Van Der Pol Oscillator

The ratio between input and output power at the resonance frequency. i.e. |S₂₁(ω_{c})|² calibrates the maximum microwave amplification of the device under external excitation (with a power of −50 dBm). Turning the microwave amplifier on through a bias voltage (V) above the threshold (Vₜₕ) leads to gain of the cavity transmission |S₂₁|²>1. Figure S9(a) plots the microwave transmission at three typical conditions: gain turn-off, near-threshold, and far above threshold. Here the VNA output power is −50 dBm, the IF bandwidth is 3 kHz, and each sweep includes 20001 sampling points. The values of the related |S₂₁(ω_{c})|² are 0.04, 16, and 2×10⁶. The cavity transmission (curve C) is sharply peaked when V>>Vₜₕ, yielding a microwave transmission as high as 2×10⁶, which is much larger than the gain of the integrated microwave amplifier. The extracted |S₂₁(ω_{c})|² plot is plotted as a function of the bias voltage in Fig. S9(b), where a four-orders of magnitude change appears between 0.5 V and 1 V.

### S3.4. Coherent Coupling Strength J

We set V=0.82 V (>Vₜₕ) and measure the ω−ωₘ transmission mapping. As shown in Fig. S10(a), we observe characteristic phenomena associated with the magnetically induced transparency.² We can model the system as a conventional CMP in a quasi-closed system according to the discussion in Sec. S1.2, and neglect the contribution due to dissipative coupling. The microwave transmission coefficient of the coupled system is written as

$${S}_{21} ( ω ) ∝ \frac{1}{i ( ω - {\tilde{ω}}_{c} ) + \frac{{J}^{2}}{i ( ω - {\tilde{ω}}_{m} )}} . \qquad ( S29 )$$

Since the amplitude A is small, we can neglect the nonlinear damping γA² term and roughly estimate (G−κ_{c})/2π=7.7 MHz based on the Lorentzian lineshape fit of |S₂₁|² for the bare cavity. Using the predetermined parameter κₘ/2π=0.9 MHz, we can reproduce the |S_{21|}² spectrum at Δ=0 according to Eq. (S29) with only one adjustable parameter J/2π=4.5 MHz.

### S3.5. Indirect Coupling Strength I

Setting V=7 V, where ω_{c}/2π=3.588 GHz, we observe characteristic hysteresis of the Ω−Δ curve as shown in Fig. S11. The GDP peak position data are obtained from FIG. 2 in the main text. We perform four typical measurement procedures
(a) Down-sweep under no-memory setting: Sweep down the magnetic field to the desired value, turn on the device, measure the S₂₁(ω) spectrum, turn off the device, and sweep down to the next field.
(b) Up-sweep under no-memory setting: Same as case 1 except for sweeping up the magnetic field.
(c) Down-sweep under memory setting: Keep the device on and sweep down the magnetic field.
(d) Up-sweep under memory setting: Keep the device on and sweep up the magnetic field.

For the first three cases, the transition jumps appear near Δ_{c}/2π≈18 MHz; however, for the last case, the transition jump is near Δ_{c}/2π≈40 MHz. These features are in agreement with our theoretical model discussed in Sec. S1.6. For quantitative analysis, we adjusted G, T and ø to fit the experimental data (symbols) according to Eq. (S21). Another unknown parameter γ is estimated from the cavity photon number N according N=(G−κ_{c})/γ based on the photon statistics of the coherent microwave emission experiment discussed in Sec. S3.6. The solid curves are the simulation results. Therefore, from the experimental measurements, we obtained the complete device parameters in Eq. (S21): G/2π=312 MHz, κ_{c}/2π=142 MHz, γ/2π=2.6×10⁻¹² MHz, J/2π=4.5 MHz, Γ/2π=6.1 MHz, φ=37°, and κₘ/2π=0.9 MHz.

### S3.6. Power Spectral Density

We use the N9010A EXA signal analyzer from Keysights Technologies to measure the microwave emission from the free-running GDP devices. Unless specified, the IF bandwidth is 1 kHz, and each sweep includes 10001 sampling points. Figure S12(a) shows the power spectral density S(f) of the microwave radiation at three typical conditions: gain turn-off, near-threshold, and far above threshold for the bare cavity. The free-running spectrum is sharply peaked around ωc when turning on the gain; meanwhile, the noise floor increases. To clearly see the threshold effect, we measured the microwave emission power (Pₑ=∫S(f)df) as a function of the bias voltage V and plotted it in Fig. S12(b). We can further estimate the photon number according to

$$N = \frac{{P}_{c}}{h {ω}_{c}} \frac{2 π}{κ} .$$

As shown in rig. S12(c), there is a rapid increase (×10⁵) in the photon number near the threshold V~0.75 V. Correspondingly, a transition from conventional cavity-magnon polariton behaviour to gain-driven polariton behaviour occurs.

### S3.7. Photon Statistics of the Coherent Microwave Emission

To characterize the GDP device's coherence behaviour, we have analyzed the photon statistics of the radiation emitted from the free-running GDP at Δ=0. The coherence over a long period is measured by plotting a 2D IQ histogram. The microwave radiation for the device is first down-converted to MHz signals through the ADL5380 from Analog Devices, and then the in-phase and quadrature-phase components I and Q are recorded by a DSAX91604A Infiniium oscilloscope from Keysights Technologies with a sampling rate up to 40 GSa/s. The ADL5380 is a broadband quadrature IQ demodulator covering an RF/IF input frequency range from 400 MHz to 6 GHz. Near 3.6 GHz, its IQ phase accuracy is about 1.1°, and the IQ magnitude imbalance is about 0.14 dB. The MG3692C signal generator from Anritsu provides a 0 dBm microwave signal and acts as a local oscillator for the ADL5380. We use the built-in capabilities of the DSAX91604 Infiniium oscilloscope with 2 points sin(x)/x interpolation and the 1 GHz low pass filter (to remove the high order harmonic signal). Finally, we store 8×10⁵ to 8×10⁷ individual (I, Q) measurements in 2D histograms D(I, Q) to analyze their statistical properties. The sampling time should be at least ten times greater than the coherence time Tc of the emitted microwave.

### S3.7A. Noise Background Calibration

We first set the device at the zero bias voltage and zero magnetic field, and directly record the histogram D(I, Q) of the background noise throughout 10 μs, see Fig. S13(a). The I and Q axes of the histograms are scaled so that the average photon number calculated from the IQ histogram ∫∫D(I, Q)(I²+Q²)dIdQ equals the effective noise number Nₙₒᵢₛₑ. The thermal noise can be estimated according to

$${N}_{noise} = 1 / ( {e}^{\frac{ℏ ω}{{κ}_{b} T}} - 1 ) ∼ 1800$$

at room temperature. As shown in Fig. S13(b), the photon noise distribution p(N) is well fit by a thermal distribution with a form p(N)∝e^{-N/N}^{ₙₒᵢₛₑ} and the probability density function satisfies

$${\int }_{0}^{+ ∞} P ( N ) dN ≡ 1$$

### S3.7B. Near Threshold

For the second IQ histogram measurement, we set the bias voltage V=0.77 V (corresponding to G/2π~150 MHz, i.e., G~κ_{c}) close to the threshold Vₜₕ and the magnetic field for zero detuning Δ~0, where ωₘ/2π=ω_{c}(0.77V)/2π=3.493 GHz and Ω/2π=3.499 GHz. By integrating the emission data measured by the signal analyzer, we estimate the output power Pₒᵤₜ=∫S(f)df=2.2 μW, corresponding to an average photon number N̅+Nₙₒᵢₛₑ=3.40×10¹⁰. The histogram D(I, Q) of the photon emission is recorded for 350 μs. In contrast, when the device is near the threshold, the IQ-plot takes on a significantly different shape, similar to a donut,^{15,16} as shown Fig. S14(a).

The outer rings correspond to coherent radiation, and follows a Gaussian distribution

$$∝ {e}^{- \frac{{( N - \overline{N} )}^{2}}{2 {σ}^{2}}}$$

with a radius of N̅=(2.90±0.04)×10¹⁰ and a standard deviation σ=(1.30±0.03)×10¹⁰.

When the bias voltage is slightly above the threshold, the fluctuation caused by the noise amplified by the gain device could occasionally shift the system below the threshold, leading to the significant thermal component observed as the inner circle. This component follows a thermal distribution

$$∝ {e}^{- \frac{N}{{N}_{noise}}}$$

with a much higher noise number of Nₙₒᵢₛₑ=(5.0∓0.4)×10⁹ because turning on the gain device also amplifies the noise. The calculation (solid line) by including both noise and coherent radiation can well reproduce the photon distribution p(N) as shown in Fig. S14(b). Based on the relative weight between the thermal distribution and the Gaussian distribution, we estimate that the system spends more than 15% of the time below the threshold.

To clearly see the role of noise fluctuations in our GDP device, Figure S15(a) plots a time series of the demodulated free-running coherent microwave emission over a period of 350 μs with 1.4×10⁷ individual data points. The oscillation of the superthreshold state and noise of the subthreshold states appear alternatively, highlighted in the magnified figures [Fig. S15(b) and Fig. S15(c)], respectively. Besides the amplitude fluctuation, occasional phase slips shown in Fig. S15(b) result in a loss of coherence, leading to a broadened emission line.

### S3.7C. Far Above Threshold

For the third IQ histogram measurement, we set the bias voltage V=7 V (corresponding to G/2π=312 MHz, i.e., G~κ_{c}>>0) much higher than the threshold Vₜₕ, and the magnetic field at zero detuning Δ=0. When the IQ demodulator is added into the measurement circuit, the cavity mode is slightly blue shift 6 MHz compared with other SA and VNA measurements. In this case, the emission photon has a frequency of Ω/π×=3.600 GHz at Δ=0 and ω_{c}/2π=3.594 GHz for the bare cavity. The histogram D(I, Q) of the photon emission is recorded for 100 ms, and the result is shown in Fig. S16(a). Because there are no subthreshold states, only a single ring appears in the IQ spectrum, related to the coherent emission.

By integrating the emission data measured by the signal analyzer in FIG. 3(a), we estimate the output power Pₒᵤₜ=∫S(f)df=4.3 mW corresponding to an average photon number N̅=(6.600±0.001)×10¹³. The photon number distribution [symbols in Fig. S16(b)] takes on a form of a Gaussian distribution

$$p ( N ) ∝ {e}^{- \frac{{( N - \overline{N} )}^{2}}{2 {σ}^{2}}}$$

with σ=(3.40±0.01)×10¹².

### S3.8. Time Domain Measurement of the Coherence Time

The long coherent time is also supported by time-domain analysis of the GDP radiation. Based on the IQ measurement, we calculate the first-order coherence function according to¹³

$${g}^{( 1 )} ( τ ) = \frac{〈 \tilde{V} ( t ) \tilde{V} * ( t + τ ) 〉}{{[ 〈 \tilde{V} ( t ) \tilde{V} * ( t ) 〉 〈 \tilde{V} ( t + τ ) \tilde{V} * ( t + τ ) 〉 ]}^{\frac{1}{2}}} , \qquad ( S30 )$$

where the angle brackets denote statistical averages, \tilde{V}=I+iQ, and its complex conjugate \tilde{V}*. The modulus of the degree of the first-order coherence is

$$\vert {g}^{( 1 )} ( τ ) \vert = exp ( - \frac{1}{2} \frac{{τ}^{2}}{{τ}_{c}^{2}} )$$

for the Gaussian broadening and

$$\vert {g}^{( 1 )} ( τ ) \vert = exp ( - \frac{τ}{{τ}_{c}} )$$

for Lorentzian broadening, where τ_{c} is the coherence time of the radiated photon.¹³

As shown in Fig. S17(b), the modulus of |g⁽¹⁾( [symbol] )| can be well-described by the solid lines according to

$$\vert {g}^{( 1 )} ( τ ) \vert = exp ( - \frac{1}{2} \frac{{τ}^{2}}{{τ}_{c}^{2}} ) .$$

For V>>Vₜₕ, the deduced coherence time τ_{c}=890 μs is in good agreement with the value extracted from lineshape fitting [Fig. S17(a)] of the microwave radiation according to τ=1/σ=880 μs. The IF bandwidth is 100 Hz for measuring the power spectral density S(f). For comparison, the coherence time at V=0 is only 0.2 ns (shorter than the period 0.28 ns for a microwave with ω_{c}/2π=3.6 GHz).

### S3.9. Injection Locking Measurement

The oscillator can be frequency locked by an external signal injected into the oscillator. Power spectral density S(f) is mapped as a function of the frequency of the injected tone (ωᵢₙⱼ/2π). An input power Pᵢₙⱼ=−30 dBm is provided by the MG3692C signal generator from Anritsu. As shown in Fig. S18(a), an injection locking range Δf=1.6 MHz is observed. Outside the injection locking regime, the injection of the off-resonant tone at ωᵢₙⱼ results in generation of higher harmonics to the GDP emission. In addition to the central emission peak, we observe a series of narrow emission peaks that shift away from the central emission peak as the absolute detuning |ωᵢₙⱼ−Ω| increases. When Ωᵢₙⱼ approaches to the GDP frequency, Q, the central emission and higher harmonics are pulled towards the injected tone until they are locked across the frequency range Δf. Without any adjustable parameter, the calculated central pulled emission and sidebands (solid lines) well-reproduce the experimental observation according to Eq. (S27) and Eq. (S28).

Within the injection locking regime, a single microwave tone appears in the power density spectrum. The injection locked emission follows a Gaussian lineshape ∝e^{-(ω-ω}ᵢₙⱼ)²/2σ² with σ/2π0.42 Hz, which is orders of magnitude narrower than the free-running GDP emission (a few hundred Hz). At the bottom of the main beam, the background signal is about six orders of magnitude weaker, roughly following a Gaussian distribution with a linewidth of σ/2π~15 Hz. As a comparison, the injected microwave signal is plotted as lighter greytone symbols, which is about 10⁴ times weaker. The S(f) in Fig. S18(b) is measured by using 1 Hz IF bandwidth, which is the minimum bandwidth of the N9010A SA.

The frequency range that the free-running GDP emission can be injection locked is strongly dependent on the injection power, as shown in Fig. S18(c). Varying the power of the injection tone, the measured Δf follows a simple relation Δf=ξ\sqrt{Pᵢₙⱼ} (solid line with ξ=60 MHz/\sqrt{mW}) as predicted in Sec. S1.7.

### S4. COMPARISON WITH REPORTED MASER AND COHERENT MICROWAVE EMITTER

Table II briefly compares the performance of coherent microwave emission/amplification between the present architecture and alternatives in the literature.¹⁴⁻¹⁹ The reported GDP emission has a longer coherent time and narrower linewidth than most of the proposed maser, demonstrating its potential in coherent microwave emission. While the resonance principle makes the presented architecture has a limited bandwidth for microwave amplification, for ex-ample, only 1.6 MHz in FIG. 4(d), the bandwidth can increase to 40 MHz by tuning the magnon frequency through the external magnetic field. One can further improve the device's bandwidth by incorporating the varactor-loaded cavity^{12,20}, where the cavity frequency can vary several hundred MHz by a DC voltage. Besides the improvement in the bandwidth, it is expected that the DC to RF efficiency can reach 50% by minimizing the energy loss of the device. This improvement can be achieved by replacing the BJT with a high-electron-mobility transistor (HEMT) and using a low-loss substrate (such as RT/Duroid®5880 Laminates).²⁰

TABLE II
Performance summary of coherent microwave emission/amplification in a cavity-based hybridized system.

| | | | Nature 555, | | Science 355, | | Science 347, | | Nature Physics | | Nature 488, | | IEEE T MTT- | |
|---|---|---|---|---|---|---|---|---|---|---|---|---|---|---|
| | | | 493-496 (2018) | | 939-942 (2017) | | 285-287 (2015) | | 10, 157-162 | | 353-356 (2012) | | 58, 1133-1139 | |
| | This work | | [Ref. 14] | | [Ref. 15] | | [Ref. 16] | | (2014) [Ref. 17] | | [Ref. 18] | | (2010) [Ref. 19] | |
| Device | Polariton | | Diamond maser | | AC Josephson | | Semiconductor | | Spin defect | | Solid-state | | Low-noise active | |
| Architecture | microwave | | | | junction maser | | double quantum | | maser | | maser | | microwave | |
| | emitter/amplifier | | | | | | dot maser | | | | | | resonator | |
| Cavity | Meander | | Cylindrical | | Coplanar | | Coplanar | | Cylindrical | | Cylindrical | | Square open- | |
| Structure | microstrip | | cavity | | waveguide | | waveguide | | cavity | | cavity | | loop resonator | |
| | resonator | | | | resonator | | resonator | | | | | | | |
| Cavity | 2D PCB (FR4 | | 3D Copper | | 2D NbTiN super- | | 2D Nb super- | | 3D metallic | | 3D metallic | | 2D PCB | |
| Materials | substrate) | | cavity + | | conducting | | conducting | | cavity | | cavity + | | (RO3035 | |
| | | | Sapphire ring | | resonator | | resonator | | | | Sapphire ring | | substrate) | |
| Gain Medium | Semiconductor | | NV⁻ centres in | | Josephson | | Quantum dot | | Silicon vacancy | | Organic mixed | | Semiconductor | |
| | transistor | | diamond | | junction | | | | defects in SiC | | molecular | | transistor | |
| | | | | | | | | | | | crystal | | | |
| Gain | Amplifier | | Optical | | Amplifier | | Amplifier | | Optical | | Optical | | Feedback | |
| Technique | embedded | | excitation | | embedded | | embedded | | excitation | | excitation | | circuit | |
| | resonator | | | | resonator | | resonator | | | | | | | |
| Operating | ~3.6 | GHz | ~9.2 | GHz | ~5.7 | GHz | ~7.9 | GHz | ~9.4 | GHz | ~1.45 | GHz | ~8.0 | GHz |
| Frequency | | | | | | | | | | | | | | |
| Operating | Room | | Room | | 15 | mK | 4K | | Room | | Room | | Room | |
| Temperature | temperature | | temperature | | | | | | temperature | | temperature | | temperature | |
| Linewidth | 360 | Hz | 50 | Hz | 21.4 | kHz | 34.2 | kHz | ~16 | MHz | ~6 | kHz | 11 | MHz |

| (FWHM) | | | | | | | | | | | | | |
|---|---|---|---|---|---|---|---|---|---|---|---|---|---|
| Q-factor | ~10⁷ | | ~10⁸ | | ~10⁵ | | ~10⁵ | | ~10³ | ~10⁵ | | ~10³ | |
| *Emission | 890 | μs | 6.4 | ms | 15 | μs | 14.6 | μs | N/A | N/A | | N/A | |
| Coherence | | | | | | | | | | | | | |
| Time | | | | | | | | | | | | | |
| Injection | 0.84 | Hz | N/A | | 1 | Hz | N/A | | N/A | N/A | | N/A | |
| Locked | | | | | | | | | | | | | |
| Linewidth | | | | | | | | | | | | | |
| Maximum | 40 MHz via | | 0.15 | MHz | N/A | | N/A | | N/A | N/A | | N/A | |
| Amplification | biased magnetic | | | | | | | | | | | | |
| Bandwidth | field of a YIG | | | | | | | | | | | | |
| | sphere | | | | | | | | | | | | |
| Bistability | Yes | | No | | No | | No | | No | No | | No | |
| Maximum | 4.3 | mW | 0.8 | pW | 0.26 | pW | 0.36 | pW | N/A | 0.1 | mW | 10 | mW |

| Output RF | | | | | | | | | | | | | |
|---|---|---|---|---|---|---|---|---|---|---|---|---|---|
| Power | | | | | | | | | | | | | |
| Input DC/ | 140 | mW | 500 | mW | 0.81 | pW | N/A | 600 | mW | 1.5 | kW | 200 | mW |

| | | | | | | | |
|---|---|---|---|---|---|---|---|
| Laser Power | | | | | | | |
| DC/Laser to | 0.03 | 1.6 × 10⁻¹⁷ | 0.31 | N/A | N/A | 6.7 × 10⁻⁸ | 0.05 |
| RF Efficiency | | | | | | | |

*The emission coherence time of the novel work disclosed herein, as well as that of Ref. 15 (AC Josephson junction maser) and Ref. 16 (Semiconductor double quantum dot maser), are deduced from the first-order autocorrelation function by measuring the statistics of the emitted photons. The emission coherence time for Ref. 14 (Diamond maser) is estimated from the emission linewidth.

### CITED REFERENCES FOR PRECEDING “SUPPLEMENTAL” CONTENT

1 L. D. Landau and E. M. Lifshitz, Mechanics, 3rd ed. (Pergamon Press, Oxford, 1976).
2 X. Zhang, C.-L. Zou, L. Jiang, and H. X. Tang, Strongly Coupled Magnons and Cavity Microwave Photons, Phys. Rev. Lett. 113, 156401 (2014).
3 B. van der Pol, A theory of the amplitude of free and forced triode vibrations, Radio Review (later Wireless World) 1, 701-710 (1920)
4 L. Gilles and P. Knight, Two-photon absorption and nonclassical states of light, Phys. Rev. A 48, 1582 (1993).
5 T. E. Lee and H. R. Sadeghpour, Quantum Synchronization of Quantum van der Pol Oscillators with Trapped Ions, Phys. Rev. Lett. 111, 234101 (2013)
6 N. Minorsky, Nonlinear Oscillations (Krieger Publishing Company, 1974).
7 J. W. Rao, Y. P. Wang, Y. Yang, T. Yu, Y. S. Gui, X. L. Fan, D. S. Xue, and C.-M. Hu, Interactions between a magnon mode and a cavity photon mode mediated by traveling photons, Phys. Rev. B 101, 064404 (2020).
8 A. A. Clerk, M. H. Devoret, S. M. Girvin, Florian Marquardt, and R. J. Schoelkopf, Introduction to quantum noise, measurement, and amplification Rev. Mod. Phys. 82, 1155 (2010).
9 R. Adler, A study of locking phenomena in oscillators, Proc. IRE 34, 351 (1946); R. Adler, A study of locking phenomena in oscillators, Proc. IEEE 61, 1380 (1973).
10 M. Armand, On the output spectrum of unlocked driven oscillators, Proc. IEEE 57, 798 (1969).
11 Y.-Y. Liu, J. Stehlik, M. J. Gullans, J. M. Taylor, and J. R. Petta, Injection locking of a semiconductor double-quantum-dot micromaser, Phys. Rev. A 92, 053802 (2015).
12 D. M. Pozar, Microwave Engineering, 4th ed. (John Wiley & Sons, New York, 1998).
13 R. Loudon, The Quantum Theory of Light, 2nd Ed. (Clarendon, Oxford, 1983).
14 J. D. Breeze, E. Salvadori, J. Sathian, N. M. Alford, and C. W. M. Kay, Continuous-wave room-temperature diamond maser, Nature 555, 493 (2018).
15 M. C. Cassidy, A. Bruno, S. Rubbert, M. Irfan, J. Kammhuber, R. N. Schouten, A. R. Akhmerov, and L. P. Kouwenhoven, Demonstration of an ac Josephson junction laser, Science 355, 939 (2017).
16 Y.-Y. Liu, J. Stehlik, C. Eichler, M. J. Gullans, J. M. Taylor, and J. R. Petta, Semiconductor double quantum dot micromaser, Science 347, 285 (2015).
17 H. Kraus, V. a. Soltamov, D. Riedel, S. Vath, F. Fuchs, A. Sperlich, P. G. Baranov, V. Dyakonov, and G. V. Astakhov, Room-Temperature Quantum Microwave Emitters Based on Spin Defects in Silicon Carbide, Nat. Phys. 10, 157 (2014).
18 M. Oxborrow, J. D. Breeze, and N. M. Alford, Room temperature solid-state maser, Nature 488, 353-356 (2012).
19 M. Nick and A. Mortazawi, Low phase-noise planar oscillators based on low-noise active resonators, IEEE Trans. Microw. Theory Techn., MTT-58, 1133-1139 (2010).
20 M. Nick, New Q-enhanced planar resonators for low phase noise radio frequency oscillators, Ph.D. dissertation, Dept. lectrical Eng., Michigan Univ., Ann Arbor, MI (2011).

The scope of the claims should not be limited by the preferred embodiments set forth in the examples but should be given the broadest interpretation consistent with the specification as a whole.

1. A device for outputting a microwave signal, comprising:
one or more ports each arranged for coupling to an external microwave circuit configured to emit or receive microwaves, wherein the one or more ports include an output one of the ports configured to emit the microwave signal;
a microwave structure operatively coupled to the one or more ports and configured to transmit the microwave signal, wherein the microwave structure includes:
one or more transmission lines respectively associated with the one or more ports, wherein each of the transmission lines spans from a first end free of electrical connection to a second end electrically connected to an associated one of the one or more ports;
an active cavity resonator electrically or magnetically coupled to each of the one or more transmission lines, wherein the active cavity resonator is configured to form a regenerative microwave signal at a prescribed resonant frequency which is exhibited along the one or more transmission lines, wherein the active cavity resonator includes a passive cavity structure configured to define the prescribed resonant frequency by supporting a standing microwave having a wavelength inversely proportional to the prescribed resonant frequency, and wherein the active cavity resonator further includes a microwave amplifier electrically connected to the passive cavity structure and configured to augment a magnitude of the standing microwave supported by the passive cavity structure whereby the standing microwave exhibits self-oscillation;
a magnetic source arranged to provide a static magnetic field; and
a ferromagnetic body disposed in the static magnetic field and proximal to the microwave structure so as to be located in presence of electromagnetic fields emanating from the microwave structure and arranged so that an induced electromagnetic field emanating from the ferromagnetic body having a resonant frequency interacts with the electromagnetic fields of the microwave structure to form a pair of hybridized polariton modes, only one of the pair of hybridized polariton modes acting to output the microwave signal.

2. The device of claim 1 wherein a position of the ferromagnetic body relative to the microwave structure is adjustable such that the device is configured to be tuned to output the microwave signal having different frequencies.

3. The device of claim 1 wherein the active cavity resonator includes a variable capacitor having a capacitance value that is adjustable and electrically connected to the passive cavity structure such that the prescribed resonant frequency of the active cavity resonator is variable by changing the capacitance value of the variable capacitor.

4. The device of claim 1 wherein the magnetic source is a permanent magnet.

5. The device of claim 1 wherein the ferromagnetic body comprises a ferrimagnetic material.

6. The device of claim 1 wherein the ferromagnetic body comprises yttrium iron garnet.

7. The device of claim 1 wherein the microwave structure is formed on a printed circuit board such that the one or more transmission lines and the passive cavity structure are respectively in the form of a microstrip.

8. The device of claim 1 wherein the passive cavity structure is in the form of a transmission line following a non-linear path between opposite ends which are free of electrical connection with the one or more transmission lines respectively associated with the one or more ports.

9. The device of claim 1 for use as an amplifier when the one or more ports includes an input one of the ports configured to receive an input microwave signal.

10. The device of claim 1 wherein the microwave amplifier comprises a transistor configured for use as an amplifier.

11. The device of claim 10 wherein the transistor is a bipolar junction transistor (BJT).

12. The device of claim 10 wherein the transistor is a high electron mobility transistor (HEMT).

13. The device of claim 10 wherein the transistor is a metal-semiconductor field-effect transistor (MESFET).
